(19) United States
(12) Patent Application Publication
(10) Pub. No.: US 2019/0228357 A1
(43) Pub. Date: Jul. 25, 2019

(54) INSIGHT AND LEARNING SERVER AND SYSTEM

(71) Applicant: Pulsify, Inc., Wellesley, MA (US)

(72) Inventors: Bennett Alexander Fisher, Wellesley, MA (US); Paul Joseph Gagne, Reading, MA (US); Adam Kernander, Dover, NH (US)

(21) Appl. No.: 16/258,388

(22) Filed: Jan. 25, 2019

Related U.S. Application Data
(60) Provisional application No. 62/622,021, filed on Jan. 25, 2018.
(60) Provisional application No. 62/741,699, filed on Oct. 5, 2018.

(51) Int. Cl. G06Q 10/06; G06N 7/00; G06N 20/00; G06F 3/0482

(52) U.S. Cl. CPC G06Q 10/0635; G06Q 10/06393; G06F 3/0482; G06N 20/00; G06N 7/005

(57) ABSTRACT

A system and method including a processor, and a non-transitory computer-readable storage medium for tangibly storing thereon program logic for execution by the processor to create a rating display including an interactive questionnaire, display, menu or list with at least some sentiment-related information. Employee sentiment data generated based on the rating display is received and stored from at least one employee and/or at least one manager. The employee sentiment data includes employee check-ins and/or manager check-ins or inputs to the sentiment-related information. Sentiment profiles of one or more employees are created including a sentiment rating, associated sentiment reason, and associated learning. Logic executed by the processor can link a display of the sentiment rating, associated sentiment reason, and associated learning to educational materials.

### RELATED APPLICATIONS

This application claims the benefit of and priority to U.S. Provisional Application No. 62/622,021, filed Jan. 25, 2018, entitled “Employee Engagement Server and System”, and to U.S. Provisional Application No. 62/741,699, filed Oct. 5, 2018, entitled “Manager Insight and Employee Retention Server and System”, the contents of which are incorporated herein by reference.

### BACKGROUND

Ineffective managers are a major challenge for many companies. Whether a manager is a first-time manager, a tenured managed that was never formally trained, or somewhere in between, most managers are generally not as effective as they could be. Ineffective managers have a direct impact on attrition, employee satisfaction, overall alignment and many other critical features of an organization.

As one example, employee attrition is a widespread phenomenon that costs organizations upwards of $550B annually. When an employee leaves, a company incurs both direct costs (through replacement hiring and onboarding), and indirect costs (through lost productivity, lost engagement, and cultural impact). In some embodiments, these costs can run upwards of tens of thousands of dollars per employee depending on the role and seniority of the person.

To combat these costs, many organizations spend millions of dollars on engagement and retention related programs to try to decrease their attrition rates. One challenge with current programs is that they are not personalized, not “in the moment”, and not widely adopted. Today's programs are generally driven by input from employees, and therefore are built for a mass audience. This approach of being employee-input driven creates a confidentiality issue where companies can only provide insights down to the team level and not the individual employee, as any lower would compromise the confidentiality of the data provided by the employee. Further, most employee driven surveys are annual or quarterly in occurrence, which leads to a delay in managers being able to react to any issues across the team. Finally, as a result of being employee driven, these programs have poor adoption rates, which creates additional challenges for the validity of the results.

On the other hand, the majority of employees report that their relationship with their manager significantly impacts their overall engagement and retention. Studies have determined that organizations with a highly-engaged and committed workforce have managers who are highly invested in understanding and supporting their employees' individual drives, concerns, and needs.

Due to the focus on the employee as described above, organizations have largely left managers on their own with few tools to help them understand the different communication, motivation, and management techniques required to address the needs of an individual employee. This includes helping managers drive increased effectiveness with their recurring individual and team interactions and understanding how these interactions and related needs change over time.

In one embodiment, the Insight and Learning Server and System helps solve this problem by providing managers with a platform that enables managers to quickly and effectively collect data, analyze trends, and drive the right actions to improve employee relations, engagement, productivity, and overall retention. More specifically, it provides managers with the structure to identify any misalignments on their teams and view related trends and insights. It also delivers personalized learnings to help with specific situations to bridge the gap between the learning/training world and what is happening in real time with managers and their employees. Finally, it provides visibility to leadership and HR teams so that there is transparency and accountability up and down the organization. Because managers are providing data to this system, it is possible to provide all of these insights and actions at the individual employee level because the data is coming from the manager not only from the employee.

### SUMMARY

Some embodiments include a system comprising at least one processor. Some embodiments include a non-transitory computer-readable storage medium for tangibly storing thereon program logic for execution by the processor, the program logic comprising: logic executed by the processor for creating a rating display including an interactive questionnaire, display, menu or list with at least some sentiment-related information. Some embodiments include logic executed by the processor for receiving employee sentiment data generated based on the rating display, the employee sentiment data comprising at least in part one or more employee check-ins or one or more manager check-ins or inputs to the sentiment-related information displayed by the rating display. Some embodiments include logic executed by the processor for receiving employee sentiment data generated based on the rating display. Some embodiments include logic executed by the processor for storing in at least one database at least a portion of the employee sentiment data. Some embodiments include logic executed by the processor for creating sentiment profiles of one or more employees, the sentiment profiles comprising at least one of at least one sentiment rating and at least one associated sentiment reason, and at least one associated learning. Further some embodiments include logic executed by the processor for linking a display of at least one of the at least one sentiment rating, the at least one associated sentiment reason, and the at least one associated learning to educational materials.

In some embodiments, the overall sentiment is displayed as a colored graphic where one or more colors of the colored graphic indicates or represents a certain sentiment. In some embodiments, the overall sentiment is displayed including the color of the graphic comprises a red color and the certain sentiment is “not good”. In some embodiments, the overall sentiment is displayed including the color of the graphic comprises an orange color and the certain sentiment is “struggling”. In some embodiments, the overall sentiment is displayed including the color of the graphic comprises a yellow color and the certain sentiment is “generally okay or so-so”. In some embodiments, the overall sentiment is displayed including the color of the graphic comprises a light green color and the certain sentiment is “mostly okay”. In some embodiments, the overall sentiment is displayed including the color of the graphic comprises a green color and the certain sentiment is “doing great”.

In some embodiments of the invention, the overall sentiment comprises “not good”, “struggling”, “generally okay or so-so”, “mostly okay”, and/or “doing great” displayed as a colored graphic with a color different from a different overall sentiment.

In some embodiments, the sentiment reason is a positive or negative reason comprising at least one of their peers, team and colleagues, company direction, mission and/or goals, recognition for their work, events unrelated to work, their personal growth at the company, their role, duties, and challenges.

In some embodiments, selectable responses to the positive or negative reason of peers, team and colleagues includes their direct reports, members of other teams or departments, and peers on their team. Some embodiments include selectable responses to the positive or negative reason of company direction, mission, and/or goals includes corporate mission, company outlook, leadership, and recent major changes. Some embodiments include selectable responses to the positive or negative reason of recognition for their work includes feedback from others, compensation, and job title. Some embodiments include selectable responses to the positive or negative reason of events unrelated to work includes events unrelated to work. Some embodiments include selectable responses to the positive or negative reason of their personal growth at the company includes a career growth plan. Further some embodiments include selectable responses to the positive or negative reason of their role, duties, and challenges includes feeling challenged, appropriate resources and resourcing, personal empowerment, and job or interest alignment.

In some embodiments, the educational materials comprise at least one of educational articles, webinars, videos, research papers, studies, worksheets, and education media content.

Some embodiments include a system comprising a memory storing software instructions. Some embodiments include a computer server configured by the software instructions to: calculate sentiment and/or risk profiles from one or more employee check-ins or one or more manager check-ins or inputs to sentiment related information displayed by an interactive questionnaire or display; and use machine learning to identify and select one or more communications or communication sources including content comprising at least one of links to or articles or news, social media, videos, media content, articles, aimed at addressing one or more concerns and increasing a level of sentiment of an employee. Some embodiments, use machine learning to improve content by using feedback from the machine learning of the system by at least: tracking access of at least a portion of the content by one or more employees. Further some embodiments include updating at least a portion of the content based on the machine learning of access to at least a portion of the content.

Some embodiments include a system comprising at least one processor. Some embodiments include a non-transitory computer readable storage medium encoded with a computer program comprising instructions that when executed by the one or more processors, perform operations comprising: receiving employee sentiment data from an interactive display generated by the instructions, the sentiment data comprising one or more check-ins or one or more manager check-ins or inputs to sentiment related information displayed by the interactive questionnaire or display. Some embodiments include calculating a sentiment and risk profile from the sentiment data. Further some embodiments include generating a manager notification comprising of one or more of alert message to at least one direct or indirect manager of the employee based on a predetermined level of sentiment and/or risk.

Some embodiments include a system comprising at least one processor, and a non-transitory computer readable storage medium encoded with program logic for execution by the at least one processor. The program logic comprises logic executed by the at least one processor for receiving employee sentiment data from an interactive employee-dedicated questionnaire or display generated by the instructions, a first sentiment data comprising one or more employee check-ins or inputs to sentiment related information displayed by the interactive questionnaire or display, and second sentiment data comprising one or more manager check-ins or inputs to sentiment related information displayed by a manager dedicated interactive questionnaire or display. Some embodiments include logic executed by the at least one processor for performing a comparative analysis of the first and second sentiment data. Some embodiments include logic executed by the at least one processor for generating a manager notification comprising of one or more of alert message or display based on a predetermined level of difference between the first and second sentiment data. In some embodiments, the comparative analysis is a substantially double-blind comparative analysis.

Some embodiments include a server system comprising at least one processor. Some embodiments include a non-transitory computer-readable storage medium for tangibly storing thereon program logic for execution by the processor, the program logic comprising: logic executed by the processor for creating an employee check-in display including at least one interactive display with at least some sentiment-related questions or information associated with at least one employee. Some embodiments include logic executed by the processor for receiving data communications from inputs to the check-in display, the data communications comprising sentiment data check-in responses associated with the at least one employee. Further some embodiments include logic executed by the processor for creating at least one sentiment profile of the at least one employee.

Some embodiments include a server system comprising at least one processor. Some embodiments include a non-transitory computer-readable storage medium for tangibly storing thereon program logic for execution by the processor, the program logic comprising: logic executed by the processor for creating an interactive employee check-in display. Some embodiments include logic executed by the processor for receiving data communications from inputs to the employee check-in display, the data communications comprising employee sentiment data. Some embodiments include logic executed by the processor for creating at least one sentiment profile of the employee. Some embodiments include logic executed by the processor for creating an interactive manager check-in display including at least some sentiment-related questions, queries, or information associated with the employee. Some embodiments include logic executed by the processor for receiving data communications from inputs to the manager check-in display, the data communications comprising responses to questions or information concerning a manager's sentiment rating of at least one employee and at least one associated reason. Further some embodiments include logic executed by the processor for performing a comparative analysis of the at least one employee sentiment and associated reason and the at least one manager sentiment rating; and generating an alert message, email communication, or display based on a predetermined level of difference between the at least one employee sentiment and associated reason and the at least one manager sentiment rating.

Some embodiments include a server system comprising at least one processor. Some embodiments include a machine-learning data server including employment history data of at least one employee. Some embodiments include a non-transitory computer-readable storage medium for tangibly storing thereon program logic for execution by the processor, the program logic comprising: logic executed by the processor for receiving data communications from inputs to an employee check-in display, the data communications comprising employee sentiment data responses to the questions or information on the check-in display. Further some embodiments include logic executed by the processor creating at least one sentiment profile of an employee using at least a portion of the employment history data received from the machine-learning data server and at least some of the employee sentiment data responses.

Some further embodiments comprise logic executed by the processor for creating based at least in part on the sentiment profiles, one or more risk profiles of the employee; the risk profiles comprising at least one of: quantified risk data displayed on a manager display against a risk benchmark, quantified risk data displayed on a manager display based on cumulative time at a risk level, and quantified risk data displayed on a manager display based on a risk comparison history over time.

Some further embodiments comprise logic executed by the processor for using machine-learning based at least in part on the at least one sentiment profile to offer selectable access to educational content comprising at least one of educational articles, webinars, videos, research papers, studies, worksheets, and education media content.

Some further embodiments comprise logic executed by the processor for using machine learning to improve the educational content.

Some embodiments include a server system comprising at least one processor. Some embodiments include a non-transitory computer-readable storage medium for tangibly storing thereon program logic for execution by the processor, the program logic comprising: logic executed by the processor for receiving data communications from inputs to an employee check-in display, the data communications comprising employee sentiment data responses and at least one associated reason to questions or information. Some embodiments include logic executed by the processor for receiving data communications from inputs to a manager check-in display, the data communications comprising responses to the questions or information concerning a manager's sentiment rating of employee and associated reason. Some embodiments include logic executed by the processor for performing a comparative analysis of the employee sentiment and associated reason and the manager sentiment rating. Further some embodiments include logic executed by the processor for using machine learning to select targeted learning content based at least in part on a quantified value of the learning content when selected based on the employee sentiment and associated reason, and the manager sentiment rating.

Some further embodiments comprise, logic executed by the processor for using machine learning to update the targeted learning content based at least in part on the quantified value.

Some embodiments include logic executed by the processor for performing the comparative analysis using one or more of the sentiment profile, at least one manager's check-in, at least one employee check-in, and machine learning to determine if the manager notification should be made.

Some further embodiments of the invention include logic executed by the processor for performing at-risk analysis using one or more of the sentiment and risk profile, at least one manager's check-in, at least one employee check-in, and machine learning to determine if the manager notification should be made.

Some embodiments include logic executed by the processor for using machine learning to improve the comparative analysis. Other embodiments include logic executed by the processor for using machine learning to improve at-risk determination.

### DESCRIPTION OF THE DRAWINGS

The patent or application file contains at least one drawing executed in color.

FIG. 1A illustrates a manager check-in display in accordance with some embodiments of the invention.

FIG. 1B illustrates an extension of the manager check-in display of FIG. 1A in accordance with some embodiments of the invention.

FIG. 2 illustrates an employee check-in screen in accordance with some embodiments of the invention.

FIGS. 3A-3B and 4A-4B illustrate employee check-in displays accordance with some embodiments of the invention.

FIG. 5 illustrates a team dashboard or display in accordance with some embodiments of the invention.

FIG. 6 illustrates an individual employee's display in accordance with some embodiments of the invention.

FIG. 6A illustrates a sentiment trend chart in accordance with some embodiments of the invention.

FIG. 6B illustrates a sentiment distribution chart in accordance with some embodiments of the invention.

FIG. 6C illustrates a cumulative reasons chart in accordance with some embodiments of the invention.

FIG. 6D illustrates a reasons trend chart in accordance with some embodiments of the invention.

FIGS. 6E-6F illustrate at-risk trend charts in accordance with some embodiments of the invention.

FIGS. 6G-6H illustrate misaligned trend charts in accordance with some embodiments of the invention.

FIG. 6I illustrates an assessment trends chart a in accordance with some embodiments of the invention.

FIG. 7 illustrates a service component architecture of the insight and learning server and system in accordance with some embodiments of the invention.

FIG. 8 illustrates a computing system configured for processing the insight and learning server and system in accordance with some embodiments of the invention.

FIG. 9 shows a machine learning for an at-risk employee architecture of the insight and learning server and system in accordance with some embodiments of the invention.

FIG. 10 shows a software component architecture of the insight and learning server and system in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein, have many useful alternatives, and fall within the scope of embodiments of the invention.

Unless specified or limited otherwise, as used herein, the term “company” defines a set of employees or independent contractors affiliated with an organization and/or who share the same email domain (e.g., such as google.com). Google® is a registered trademark of Google Inc., of Mountain View, Calif. Employees are typically organized into teams with a team having a manager (also referred to as a team lead). As used herein, the manager is a person who has been identified by the company to lead a group of employees or independent contractors or is a user of professional or other services. In some embodiments, the manager can be a direct manager, and in some other embodiments, the manager can be an indirect manager. In some embodiments, the manager and employee can be employees of a company or entity. In other embodiments, the manager can be a non-employee consultant or other independent contractor of the company or entity. In some further embodiments, the employee can be a temporary employee. In some embodiments, an employee is a person working for the company who possesses an email account with the company's email domain. Unless specified or limited otherwise, a team consists of a manager and employees who are their direct reports. As used herein, one or more employees on a team may also be managers. Unless specified or limited otherwise, the term “directs” refers to employees that report directly to at least one manager. Unless specified or limited otherwise, the term “peers” refers to managers at the same organizational level as the manager reporting to the same manager or managers. Unless specified or limited otherwise, any described organization consists of a team and all of the members of subordinate teams. Unless specified or limited otherwise, the term “assessment” refers to an activity performed on a regular periodic basis (e.g. every week) by the manager with each of the employees on his or her team with the main purpose of assessing overall employee disposition and supporting reasons across multiple dimensions.

Unless specified or limited otherwise, in some non-limiting embodiments, the results of a check-in can comprise of one or more of the following: the rating of overall employee disposition; one or more specific concerns selected from a list of supporting reasons; and free-form optional notes. Other embodiments can relate to action/times or next steps. Unless specified or limited otherwise, a rating can provide an overall assessment score that serves as a summary of the state of mind of an employee after a check-in. Unless specified or limited otherwise, a period is the frequency of check-ins, e.g. every week, every two weeks, monthly, etc. Unless specified or limited otherwise, a timeframe can be a start and end date range that defines a set of periods. Unless specified or limited otherwise, an authentication service can be a component within the service that provides user authentication.

Some embodiments include the insight and learning server and system that uses software as a service platform (e.g., a “SaaS” platform) that is designed to help managers assess and monitor an employee's overall disposition, and/or provide the right amount of direction and support needed to maximize their on-going satisfaction and performance. In some embodiments, the insight and learning server and system can foster better one-on-one communications leveraging and capturing regular check-ins, one-on-ones, an/or formal or informal discussions or meetings between managers and their employees, whether individual employees or direct reports, or with teams of employees or direct reports. Further, in some embodiments, the insight and learning server and system can record the pulse of an organization as reflected by these check-ins, providing meaningful benchmarks and statistics across all levels of the organization. In some embodiments, the insight and learning server and system can propose approaches, strategies, and/or specific actions for improvement at both the employee and organizational level, it can also enable an employee's manager to compare, assess, and/or triangulate whether his or her rating or assessment is aligned or not with an employee's rating or assessment. In other embodiments, the insight and learning server and system can enable an employee's manager to compare, assess, and/or triangulate whether his or her rating or assessment provided by at least one other manager of the employee (e.g., in circumstances where the employee has more than one manager).

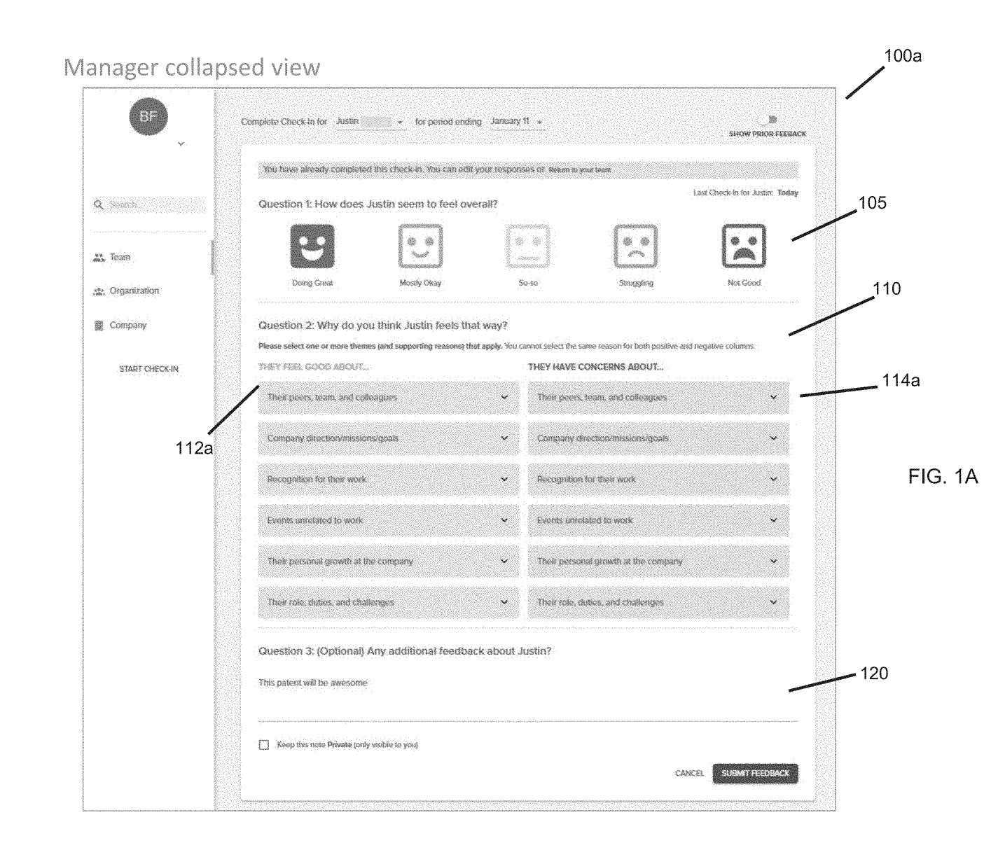

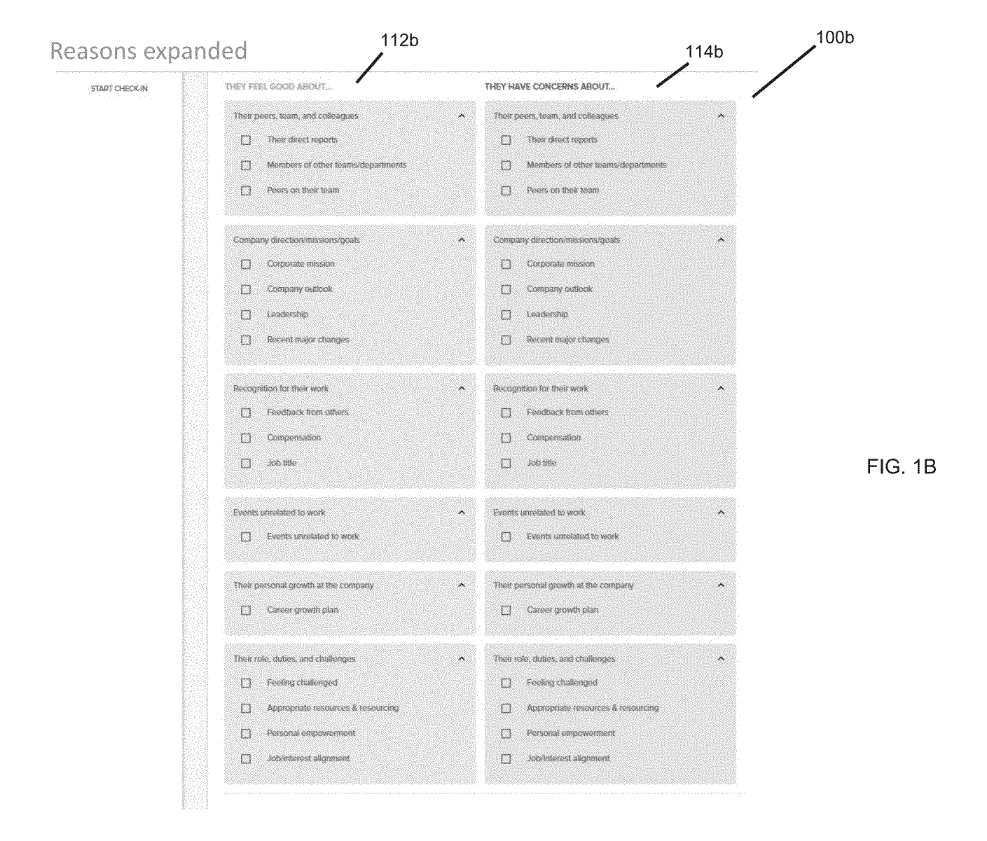

FIG. 1A illustrates a manager check-in evaluation form or display 100a in accordance with some embodiments of the invention, and FIG. 1B illustrates an extension 100b of the manager check-in evaluation form or display 100a of FIG. 1A in accordance with some embodiments of the invention. Some embodiments of the invention include a display portion or window structure 105 where the manager can select a sentiment rating related to or describing how he or she perceives an employee. Some embodiments of the invention include a display portion or window structure 110 where the manager can select a category and reason that best describes the employee sentiment rating selected. Some embodiments can include a display of selectable icons including, but not limited to, “doing great”, “mostly okay”, “so-so”, “struggling”, and “not good”. In some embodiments, an indicator of a prior rating or prior selected rating can be shown. In some embodiments, one or more reasons from a selection of positive reasons related to positive or neutral feelings (e.g., related to “doing great”, “mostly okay”, or “so-so”) can be displayed in a “they feel good about” column. In some other embodiments, one or more reasons from a selection of negative reasons related to negative feelings (e.g., related to “struggling”, or “not good”) can be displayed in a “they have concerns about” column.

In some embodiments, a rating, sentiment, or feeling can be signified using one or more colors of text and/or graphics or icons of a specific color or colors in the display portion or window structure 105. For example, in some embodiments, a rating can be a “red” rating text and/or graphic or icon indicating the employee is not good. In some further embodiments, a rating can be an “orange” text and/or graphics or icon indicative of an employee who is struggling. In some other embodiments, a rating can be a “yellow” text and/or graphic or icon indicative of an employee that is generally okay or so-so. In some embodiments of the invention, a rating can be a “light green” text and/or graphic or icon indicative of an employee who is mostly okay. In some further embodiments, the rating can be a “green” text and/or graphic or icon indicative of an employee who is doing great. In some embodiments, any color or combination of colors and any combination of text and/or graphics or icons can be used for a rating. Other embodiments can include descriptions that align with or have generally the same meaning as the above described ratings, sentiments, or feelings. Further, in some embodiments, the manager can use a notes portion 120 that can be used to provide additional information or comments regarding an employee.

In some embodiments, an overall rating is further qualified by one or more reasons that the manager can select. The reasons are important in that they provide a deeper understanding of any issues and trigger recommendations of approaches, strategies, and actions to help address them. In some embodiments, the reasons can be presented as a standard checklist organized into categories that address both positive and negative reasons for the rating given. In this way, an individual's and the overall organization's health can be assessed in both what is going well and what is not. Unless specified or limited otherwise, assessment reasons can be a categorized list of one or more reasons which qualify the assessment rating given or selected, where the manager can select one or more for each assessment. For example, in reference to the dashboard or display 100a and extension 100b, some embodiments comprise a display portion 110 that can include selectable answers to a question of why the manager thinks a specific way about an employee. In some embodiments, selectable answers in a positive category 112a can be related to what the employee feels good about, and selectable answers in a less positive, neutral, or negative category 114a are related to what the employee has concerns with. In reference to FIG. 1B, some embodiments comprise selectable answers in a positive category 112b that can be related to what the employee feels good about, and selectable answers in a less positive, neutral, or negative category 114b related to what the employee has concerns with. In both positive and negative categories, one or more reasons may be selected. The same reason may not be selected as both positive and negative. In some embodiments, the sentiment reason is a positive or negative reason comprising their peers, team and colleagues, company direction, mission and/or goals, recognition for their work, events unrelated to work, their personal growth at the company, their role, duties, and challenges. In some embodiments, selectable responses to the positive or negative reason of peers, team and colleagues includes their direct reports, members of other teams or departments, and peers on their team. In some further embodiments, the selectable responses to the positive or negative reason of company direction, mission, and/or goals includes corporate mission, company outlook, leadership, recent major changes. In some other embodiments, the selectable responses to the positive or negative reason of recognition for their work includes feedback from others, compensation, and job title. In some embodiments, selectable responses to the positive or negative reason of events unrelated to work includes events unrelated to work. In some further embodiments, selectable responses to the positive or negative reason of their personal growth at the company includes a career growth plan. In some embodiments, the selectable responses to the positive or negative reason of their role, duties, and challenges includes feeling challenged, appropriate resources and resourcing, personal empowerment, and job or interest alignment.

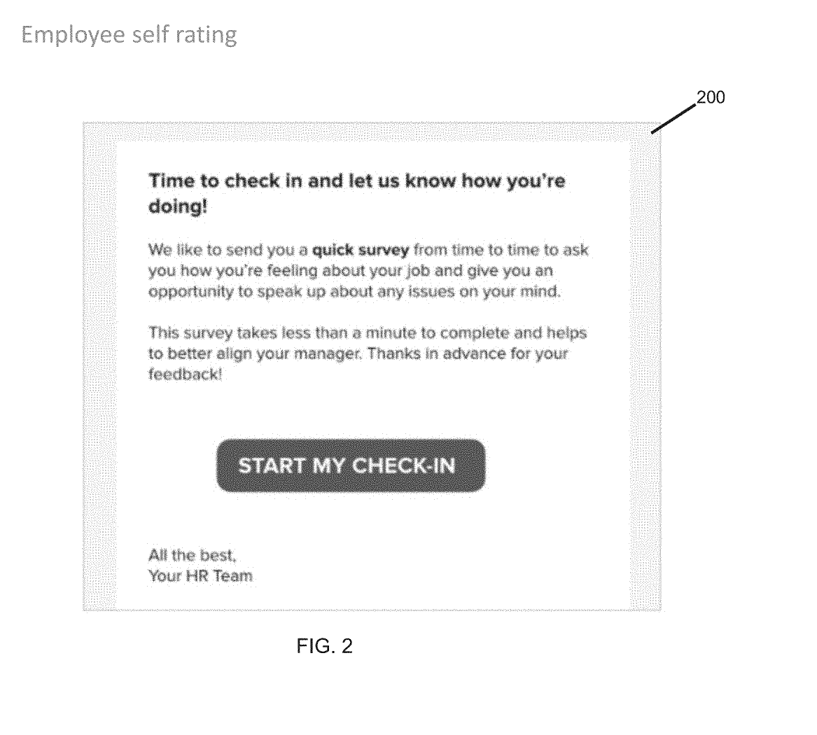

In some embodiments, the insight and learning server and system can allow a relatively quick recording or viewing of periodic assessments (e.g., periodic assessments with a frequency of weekly, bi-weekly, etc.). For example, FIG. 2 illustrates an employee check-in screen 200 in accordance with some embodiments of the invention. In some embodiments, an assessment form of the insight and learning server and system can ask for a quick overall rating that captures overall employee disposition depicted on a spectrum of green (great) to red (not good), and represented as various shading densities, colors, graphics, icons, or combinations thereof. In some embodiments, the insight and learning server and system can support multiple types of assessments. In some embodiments, the employee check-in may be a display screen, email, push notification, text message or any notification service accessible by the manager. For example, a manager assessment, assessments are performed by managers on their direct employees and summarized in the assessment overview.

In some embodiments, the insight and learning server and system can support each employee having the ability to provide an employee check-in by providing their overall job satisfaction and primary reasons for their assessment. The reason for doing this is to help the employee's manager and senior executives triangulate whether his or her rating is aligned or not. In some embodiments, the employee check-in can be a similar, but abridged version of the manager check-in, can be completed quickly, and is designed to solicit input that can be used by the employee's manager. It is also designed to provide insight into an organization.

Employee check-ins can be optional, and an organization may choose to not present the option of an employee check-into its employees/managers. For example, some embodiments include an employee check-in feature that is used to augment manager check-ins and allow employees to rate themselves in the same manner as managers (at some chosen frequency, e.g., such as every two weeks). In some embodiments, the data can be used to triangulate back to and check against the rating that the manager entered for that same employee. In some embodiments, when an employee provides a check-in, the system can utilize algorithms to compare how that assessment compares with the rating entered by the manager for that employee's overall status, and reasons, and whether the differences are significant enough to be brought to the manager's attention.

Augmenting the manager rating with an employee self-rating can help ensure that the manager accurately captures the overall sentiment of the employee without violating the confidentiality of the employee. By independently collecting both the manager and employee ratings, the system creates a double-blind or substantially double-blind system, and determines misalignment very early, so that actions can be taken to improve it. Further, the actions can be tailored not just to the individual person, but the specific reason of concern with an individual person. At-risk and/or misaligned employees can affect overall team morale, and therefore, it is very important to identify them as early as possible when corrective action can be more effective. Accordingly, systems are needed that swiftly address at-risk and/or misaligned employees with a plan of action that is appropriate for the situation.

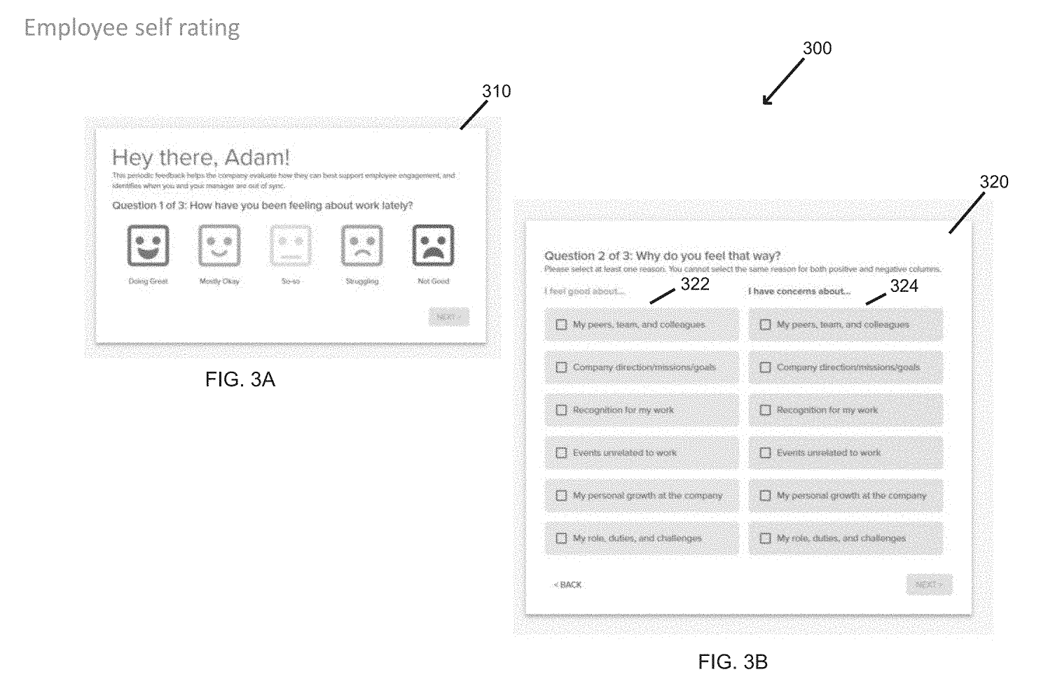

In some embodiments, a combination of the overall rating and the reasons selected can be used as inputs into the algorithms. In some embodiments, the employee check-in displays of FIGS. 3A-B and/or 4A-B can be delivered to an employee with an email. In some embodiments, this can be initiated by a manager and/or the insight and learning server and system. In some embodiments, the displays can be provided via an add-in. In some embodiments, any employee and/or manager, and/or team displays described herein can be delivered through, accessed from, or linked to an email program such as Microsoft® Outlook® and/or Google® Mail (gmail). Microsoft® and Microsoft® Outlook® are registered trademarks of Microsoft Corporation, Redmond, Wash.

In some embodiments, an employee check-in will be used to collect the employee's feelings about their job. The system may use the check-in evaluation entered by the manager and the check-in entered by the employee to determine a more accurate and comprehensive sentiment profile of the employee. Statistical analysis as well as machine learning techniques can be used to determine the sentiment profile. One aspect of the sentiment profile is determined by a double-blind process or substantially double-blind process that compares the manager check-in to the employee check-in reasons and ratings. In some embodiments, the manager and/or employee will be made aware of any misalignment and encouraged to discuss with each other. The process is considered ‘double-blind’ because neither the manager or employee are made directly aware of the other's specific responses yet any misalignment is detected and surfaced between them.

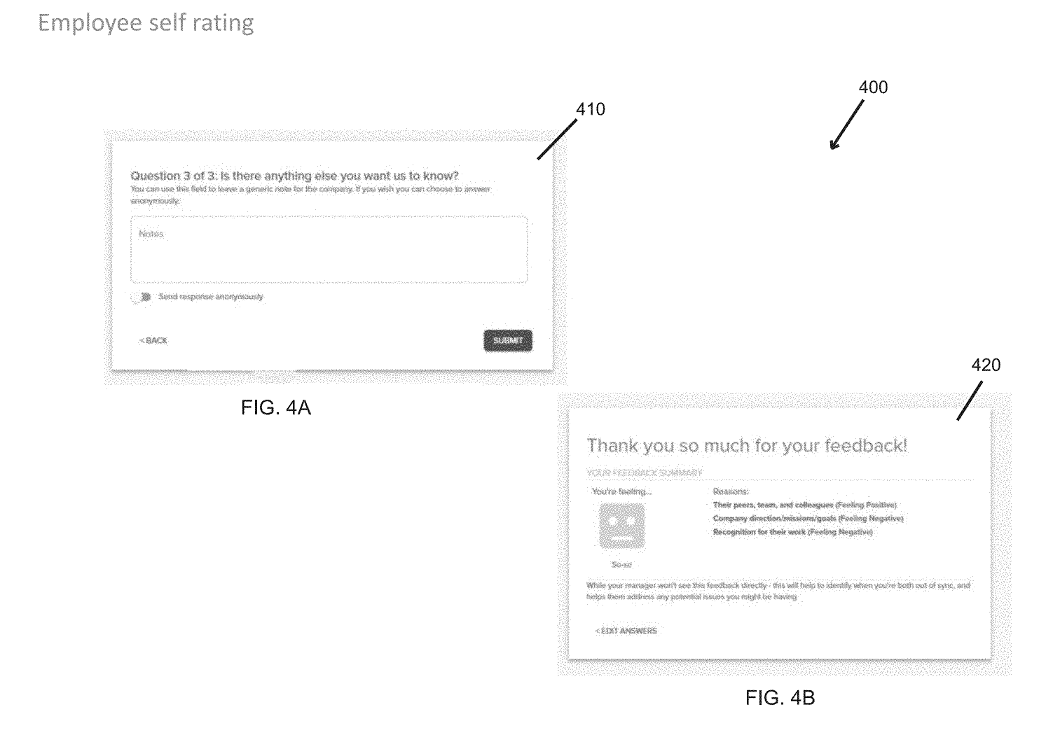

FIGS. 3A-4B illustrates an employee self-rating display 300, 400 in accordance with some embodiments of the invention. In some embodiments of the invention, the insight and learning server and system can generate one or more displays that enables an employee to provide at least one check-in. For example, in some embodiments, the check-in can comprise a rating, sentiment, or feeling that can be signified using one or more colors of text and/or graphics or icons of a specific color or colors in the display portion or window 310. For example, as shown, the insight and learning server and system generates a question asking how the employee feels, the display portion or window 310 can display a rating that can be a “red” rating text and/or graphic or icon indicating the employee is not good. In some further embodiments, a rating can be an “orange” text and/or graphics or icon indicative of the employee struggling. In some other embodiments, a rating can be a “yellow” text and/or graphic or icon indicative of the employee being so-so. In some embodiments of the invention, a rating can be a “light green” text and/or graphic or icon indicative of the employee being mostly okay. In some further embodiments, the rating can be a “green” text and/or graphic or icon indicative of the employee doing great. In some embodiments, any color or combination of colors and any combination of text and/or graphics or icons can be used for the employee self-rating display portion or window 310. Some further embodiments can include alternative descriptions that align with or have generally the same meaning as the above described ratings, sentiments, or feelings.

In some embodiments, the employee check-in display 300 can comprise a display portion 320 that can include selectable reasons to a question of why the employee thinks or is feeling a specific way. For example, in some embodiments, selectable reasons in a positive category 322 can be related to what the employee is feeling good about, and selectable reasons in a less positive, neutral, or negative category 324 are related to where the employee has concerns. The employee may not select both the positive and negative reasons of the same reason.

In reference to the employee check-in display 400, some embodiments include a window portion 410 with a question asking if the employee has anything else to communicate, and includes a notes section where the employee has the option to provide more information. In some embodiments, the employee may choose to send their notes anonymously. In some embodiments the employee's anonymous notes may only be visible to the company. Further, a window portion 420 can include information reflecting the employee's check-in including a selected rating, sentiment, or feeling comprising text and/or graphics or icons of a specific color or colors as described earlier, and one or more selected reasons.

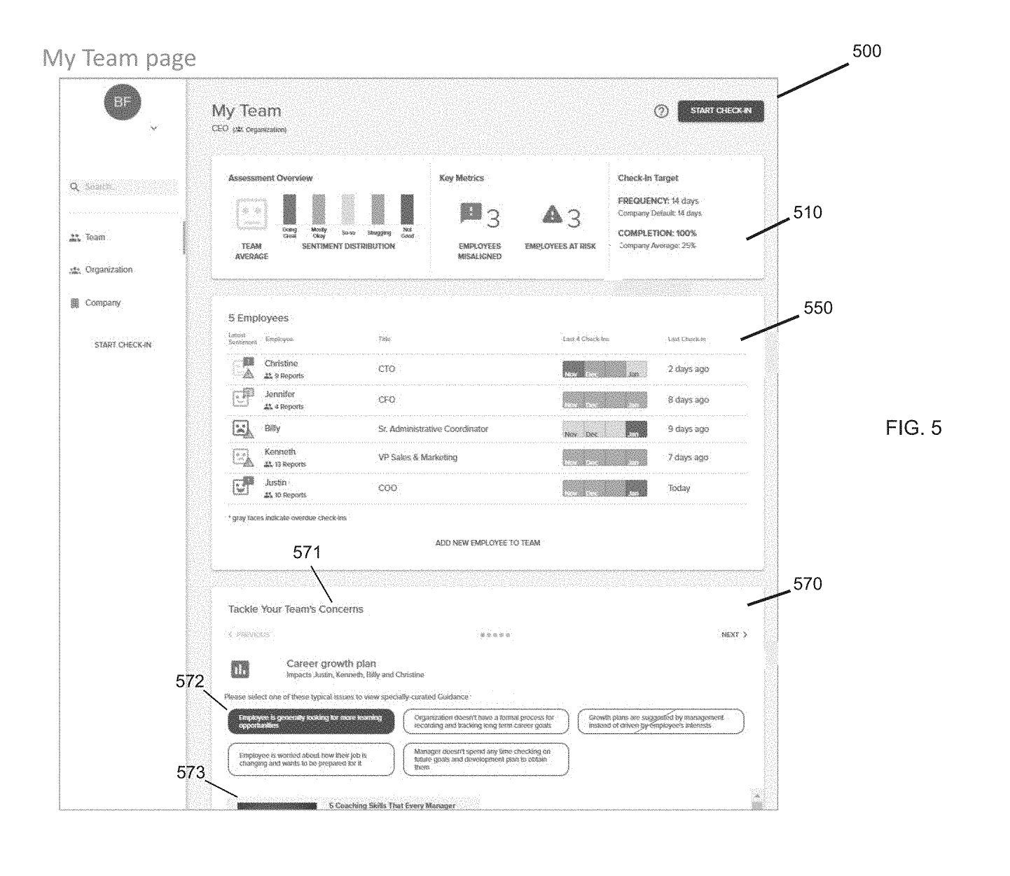

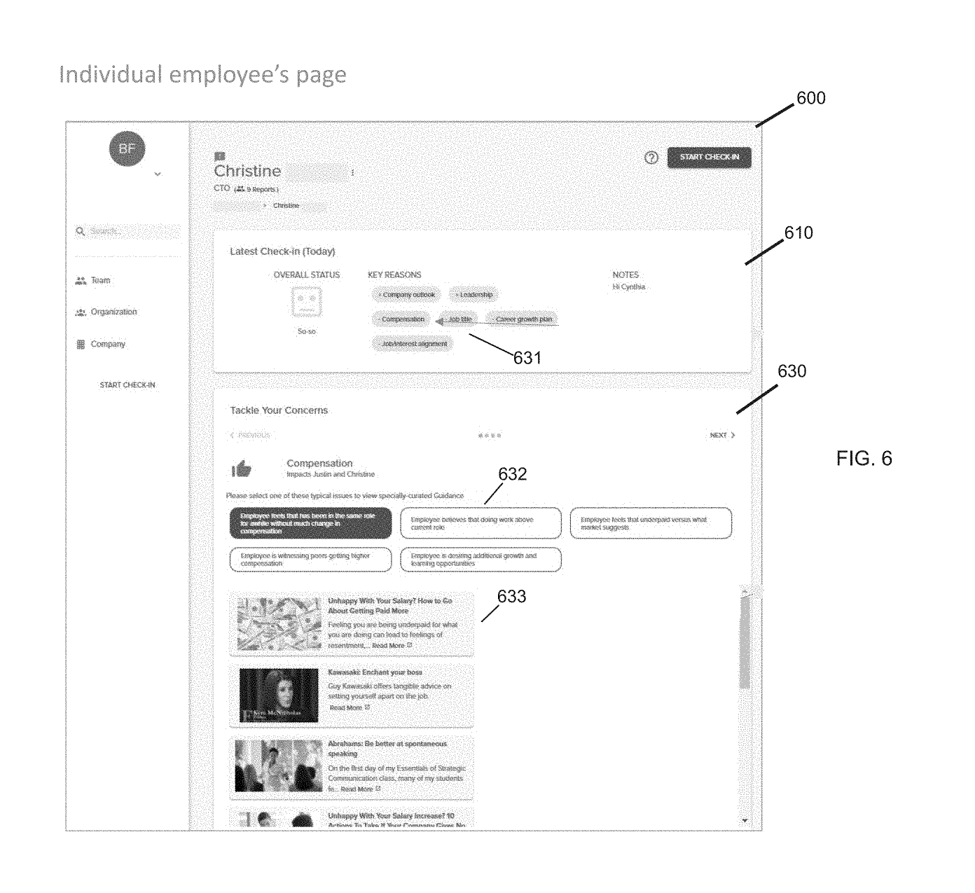

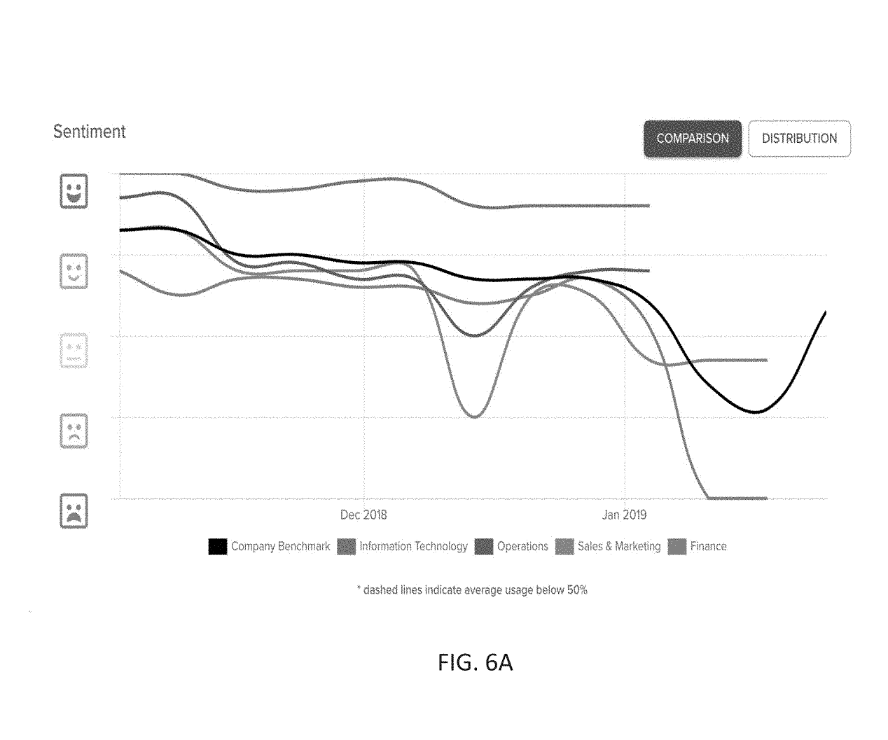

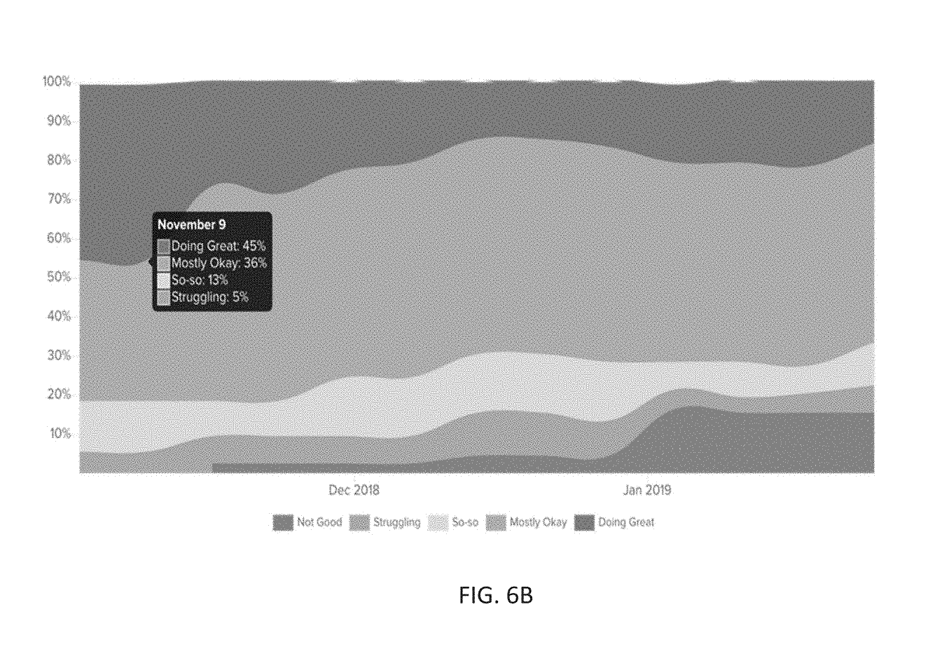

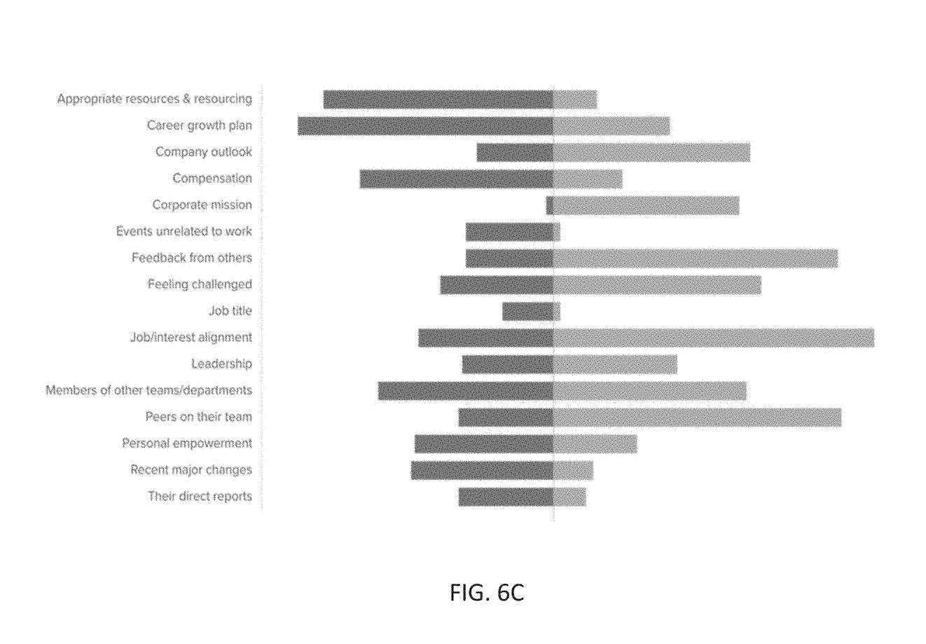

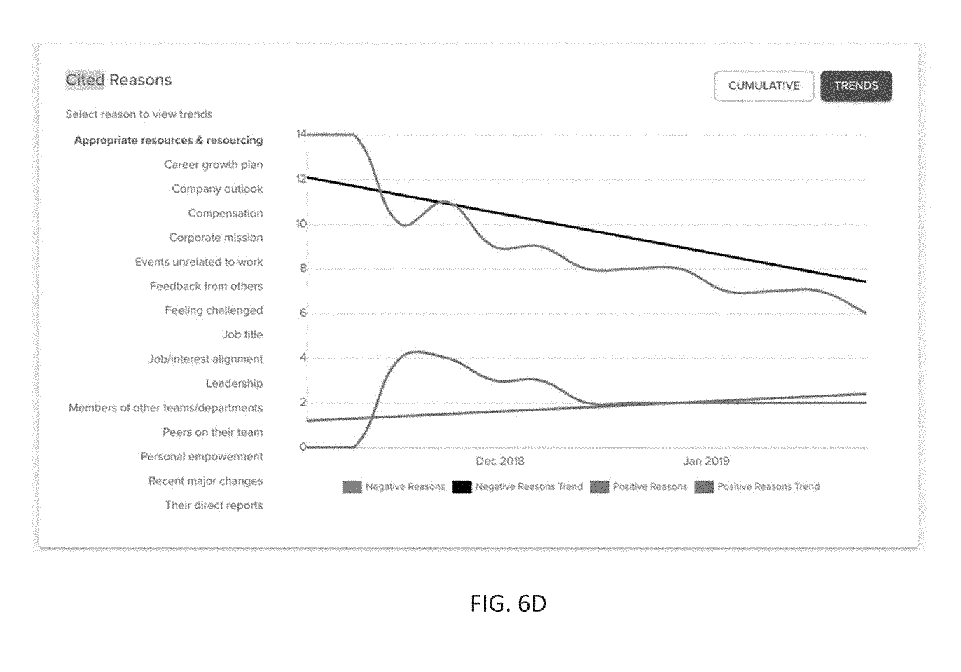

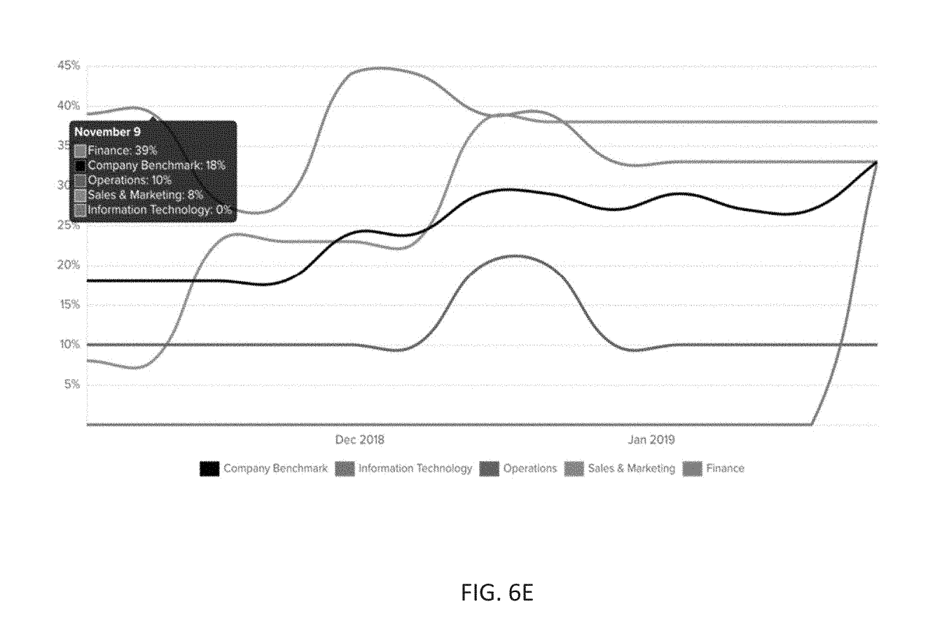

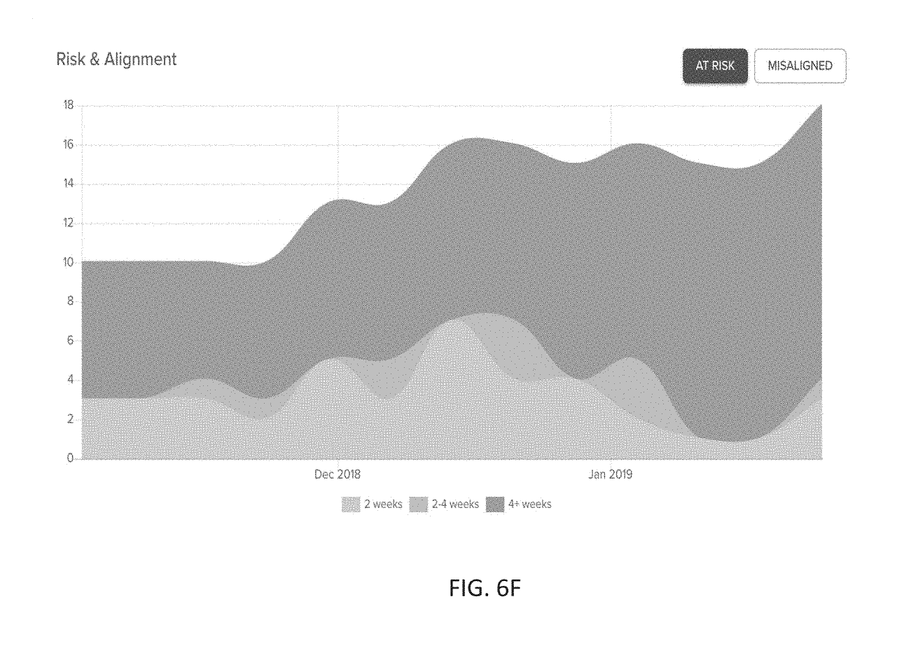

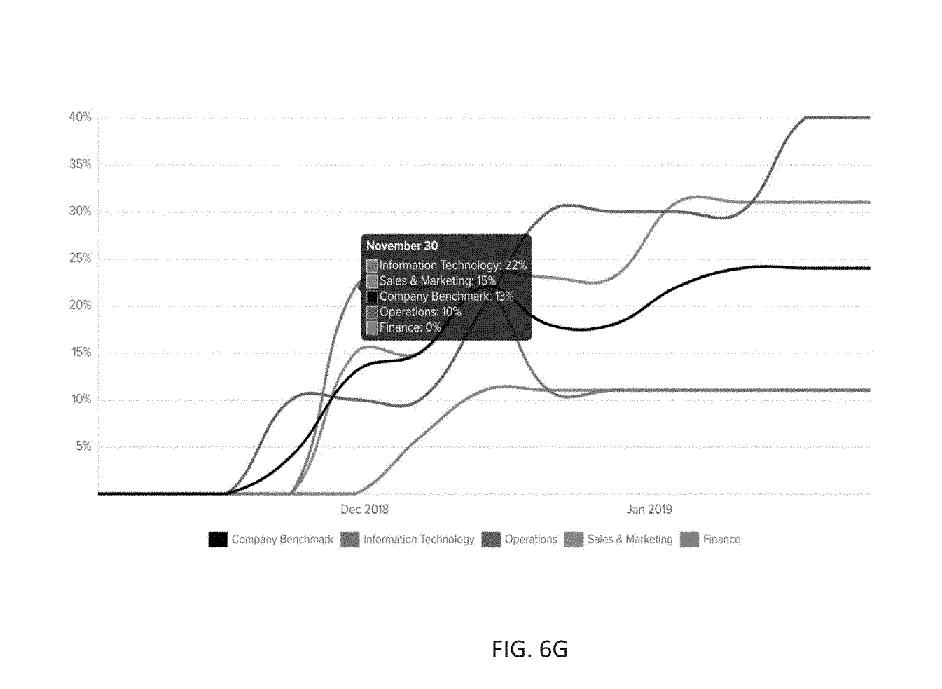

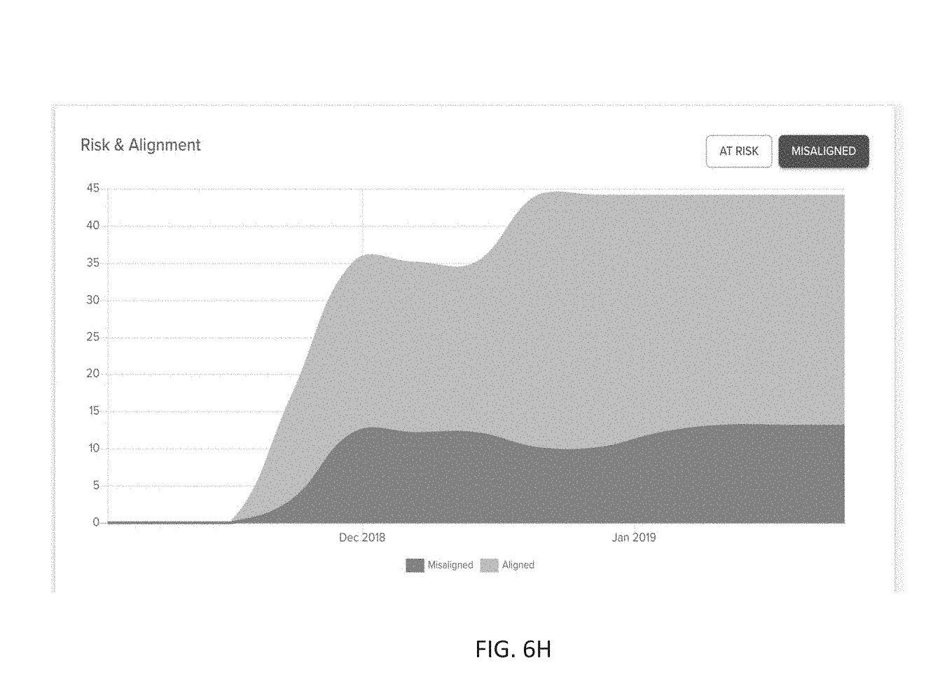

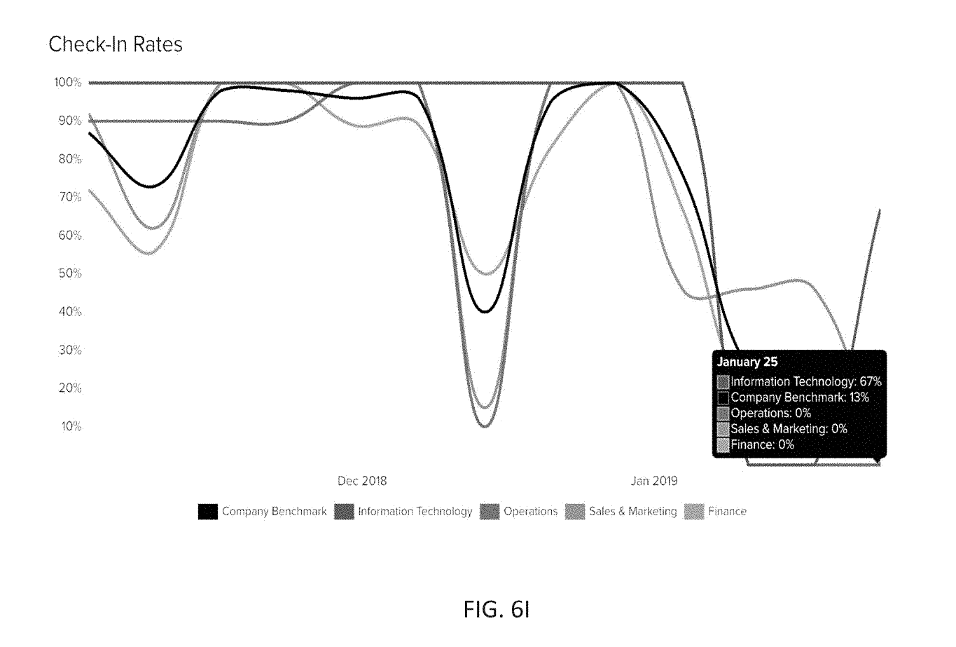

In some embodiments, analytics of the insight and learning server and system can form a backbone of several unique features of the service. In some embodiments, the analytics can allow managers to do individual check-ins, and then determine whether there are trends at the individual and team levels which could lead to actionable issues. In some embodiments, by identifying individual employee trends, the insight and learning server and system can enable a manager to have better visibility into that employee's state of mind, and thereby determine whether an individual plan is necessary (see for example FIGS. 5 and 6, and discussed further below). In some embodiments, this kind of feedback can be particularly unique since this type of individual-level insight cannot be obtained in any other way, and can have broad impact on the organization. Further, in some embodiments, by identifying team trends, a manager can address systemic issues that may be affecting all or part of a team.

In some embodiments, the insight and learning server and system can generate one or more system dashboards or displays. For example, some embodiments illustrate the power of being able to look at feedback over a period of time to determine if there are actionable issues. In some further embodiments, the insight and learning server and system can enable a user (e.g., such as a manager) to examine team-level trends. For example, in some embodiments, the insight and learning server and system can utilize an accumulation of individual trends to identify team-level issues. Some embodiments provide trend analyses chart displays that show the distribution of reasons and risk as reported for the overall team. This can be very insightful to identify team-level problems that could lead to remediation actions applicable to the whole team. The user can glean these insights by studying these visualizations and the insights in dashboards.

For example, in reference to FIG. 5, illustrating a team dashboard or display 500 in accordance with some embodiments of the invention, including, but not limited to, a team assessment overview window 510, and/or a team window 550, and/or a concerns/learning window 570. In some embodiments, the team assessment overview window 510 can comprise an assessment overview chart, and/or a key metrics display, and/or check-in statistics. In some embodiments, the team assessment overview window 510 can comprise a rating, sentiment, or feeling that is signified using one or more colors of text and/or graphics or icons of a specific color or colors as described earlier. In some embodiments, a sentiment distribution chart can be included using bars with the same or similar colors of text and/or graphics or icons. In some embodiments, the key metrics display of the team assessment overview window 510 can include an alert using one or more colors of text and/or graphics or icons.

In some embodiments, a misalignment can be represented by a shading difference of a color of text and/or graphics or icons. In some embodiments, the assessment overview chart, and/or a key metrics display, and/or check-in statistics can include the number of employees that have been determined to be misaligned, and/or the number of employees who have been determined to be at-risk. In some further embodiments, any one of the assessments performed by an employee and/or a manager of the employee can be used to evaluate promotion of the employee, compensation of the employee, and/or can be used in an evaluation of whether to keep an employee or whether to fire an employee.

In some embodiments, the employee window 550 can include the last sentiment of one or more employees of a team. In some embodiments, the last sentiment can comprise a rating, sentiment, or feeling can be signified using one or more colors of text and/or graphics or icons of a specific color or colors as described earlier. In some embodiments, the employee window 550 can include an alert using one or more colors of text and/or graphics or icons associated with the last sentiment. For example, in some embodiments, an alert comprising one or more colors of text and/or graphics or icons can indicate a declining sentiment and/or a recently updated sentiment.

In some embodiments, the concerns window 570 comprises a section related to identifying concerns that apply to one or more team members and presenting coaching material to the manager to assist them in addressing these concerns. In some embodiments, the concerns window 570 comprises a section that identifies one or more team-level concerns 571, a section 572 that presents root causes that are typically associated with the identified concern, and a section 573 that contains manager coaching material associated with a root cause. The manager may select a root cause and specific coaching material will be presented in section 573.

Some embodiments include guidance features to help managers think through, evaluate, and take actions that address areas of concern with their employees. In some embodiments, this can expose the manager to management best practices from several sources that are targeted to the specific situations he or she is currently dealing with. For example, some embodiments include one or more reasons for misalignment on overall sentiment, including categories in discussing employee titles, and/or discussing employee compensation, and/or rebalancing employee resourcing, in addition to latest check-in display.

In some embodiments, the system can identify and evaluate a manager misalignment with one or more employees as a function of time. In some embodiments, the system can be used to identify manager misalignment for focus by an organization, and/or a manager's manager.

In some embodiments, reasons that are selected by a manager can be linked to a guidance section, including, but not limited to a display that can comprise an employee's titles display section and/or creating growth plans for the employee's section. In some embodiments, guidance can be defined as a list of root causes or common reasons for the identified concern by the manager. In some embodiments, each of the root causes can be selected to open additional, more detailed content that helps the manager learn about that topic of interest. In some embodiments, content could include, but not be limited to articles, webinars, videos, research papers, studies, worksheets, and other education media content, etc. For example, in one embodiment, assuming the manager selects or clicks on a link for a desire for higher compensation, then information, education, and/or strategies related to compensation can appear on the manager's display.

In some embodiments, machine learning can be used to select targeted content based on a specific selection and/or value of the content, where machine learning can be used to update the content based on a specified or quantified value. For example, in some embodiments, the managers can select whether the article was helpful (via a vote up or down type command). Further, the next time they hit this same issue and root cause and click on the guidance topic, a different article can appear. The platform will record which articles have been seen by which managers and will show the most highly rated articles that have yet to be seen.

In some embodiments, guidance can be delivered in a way that (1) provides insight into what guidance material was selected by the manager for specific situations, and (2) determine if the material chosen was effective. In some embodiments, the feedback can be pulled back into the platform where system algorithms can be improved in an on-going and real-time manner, where the system becomes smarter and more powerful with each piece of data collected and guidance suggested.

In some embodiments, the insight and learning server and system can be used to enable a service provider's customers to conveniently provide feedback on the service provider's performance. Such customers can be automatically prompted on a periodic basis as desired by the provider, the customer or both

In some embodiments, artificial intelligence techniques can be used for decision support through the guidance process by analyzing data trends and user feedback, providing the most appropriate information to the user, and suggesting courses of action.

In some embodiments, the system can be used to support determining one or more disconnects between a manager and one or more employees. In some further embodiments, the system can be used to determine when and how guidance is shown to managers. In some other embodiments, the system can be used to determine the guidance content that is clickable. In some embodiments, the system can be used to support evaluating effectiveness of guidance techniques.

Some embodiments include an assessment overview with a display related to a team average rating (shown as a “doing great” rating icon) and/or a sentiment distribution (e.g., represented as the sentiment bar chart included on the team dashboard or display 500. Further, in some embodiments, the display can include check-in assessments including, but not limited to, an “overdue check-in” display, and/or a check-in targets display (e.g., such as with the inclusion of a frequency and/or completion display). In some further embodiments, the display can include the latest sentiment display, including the latest sentiment of one or more employees, including, but not limited to, employee title, and information showing recent check-ins and last check-ins.

FIG. 6 illustrates an individual employee's display 600 in accordance with some embodiments of the invention. In some embodiments, the individual employee's display 600 can include a display portion 610 where the manager can view his or her employee's check-in history, rating or sentiment summary comprising a rating, sentiment, or feeling that is signified using one or more colors of text and/or graphics or icons of a specific color or colors as described earlier. Further, some embodiments also include a list of one or more associated reasons that the manager has previously selected for any specific rating, sentiment, or feeling based upon the check-in between the employee and manager. In some further embodiments, a notes section can be included in the display portion 610 and can be used for notes or other related information. In some embodiments, the concerns window 630 comprises a section that identifies one or more identified employee concerns 631, a section 632 that presents root causes that are typically associated with the identified concern, and a section 633 that contains manager coaching material associated with a root cause. The manager may select a root cause and specific coaching material will be presented in section 633.

Some embodiments include manger coaching material that can be one or more links or articles to news, social media, videos, or other media content, articles, or links related to assisting a manager to address one or more employee concerns. In some embodiments, a machine learning function of the system can learn from employee behavior including manager selection of one or more links or articles to news, social media, videos, or other media content, articles, or links related to assisting a manager with addressing one or more employee concerns. In some embodiments, the one or more links or articles to news, social media, videos, or other media content, articles, or links related to assisting an employee with addressing one or more concerns can be continuously or intermittently updated based on the machine learning. In some embodiments, the system can be continuously improved using feedback from the machine learning of the system.

In some embodiments, the assessment overview information can be assimilated into a set of analytics across every period for every employee in every organization. In some embodiments, the analytics can be derived from information in the database. This information then becomes the foundation for recommendations and benchmarks. In some non-limiting embodiments, for each period, the analytics can include team level items including rating count by rating, and/or number rated, and/or team size, and/or organization size, and/or concern count by concern, and/or at-risk concern count by concern. In another embodiment, for each period, the analytics can include direct level items including rating count by rating, and/or number rated, and/or team size, and/or organization size, and/or concern count by concern, and/or at-risk concern count by concern. In some embodiments, for each period, the analytics can include peer level items including rating count by rating, and/or number rated, and/or team size, and/or organization size. In some embodiments, for each period, the analytics can include a peer's direct level items including rating count by rating, and/or number rated, and/or team size, and/or organization size. In some further embodiments, for each period, the analytics can include company level items including rating count by rating, the number rated, and/or the team size, and/or the organization size. In some other embodiments, for each period, the analytics can include a direct level item, including rating count by rating, and/or number rated, and/or team size, and/or organization size.

In some embodiments, the analytics can include company level items including the organization sentiment average and can include the teams with the highest ratings, and teams with the lowest ratings. In some embodiments, the analytics can include company level “at-risk” percentages over a period of time and can include a list of teams with the most “at-risk” percentage. In some embodiments, the analytics can include company level misalignment, including the total number of misaligned employees and can include a list of teams with the most misalignment. In some embodiments, the analytics can include company level manager usage percentages and can include the top usage employees and lowest usage employees. In some embodiments, the analytics can include company level team self-reporting, including the total number of responses and can include the top response employees and the lowest response employees. In further embodiments, the analytics can include company level trending issues, including the most viewed articles to news, social media, videos, or other media content, articles, or links related to assisting an employee with addressing one or more concerns.

In some embodiments, the insight and learning server and system can use a combination of analytics-driven logic and machine learning techniques to identify at-risk employees. In some embodiments, the analytics-driven logic can use several periods of assessments in its determination of at-risk employees, and can rely on the overall rating. In some embodiments, employee-level trends can focus on identifying at-risk employees, such as at-risk employees who have personal and/or work-related issues that are affecting their performance and happiness.

In some embodiments, benchmarks can be used by a manager to compare the relative health of their team compared to other teams and to help them determine trends that might indicate issues that should be addressed proactively. In some embodiments, the benchmarks can use empirical results, analytical (calculated) results, and periods over a certain timeframe. In some embodiments, the following analytical values can be available for benchmarks, and can be shown in the portal: rating count by rating, and/or number rated, and/or team size, and/or organization size, and/or reason count by reason, and/or at-risk reason count by reason. In some embodiments, the benchmarks can be used for comparative purposes, and the following levels of comparison can be available in the portal: employees, and/or manager, and/or manager peers, and/or organization peers, and/or company-wide. In some further embodiments, benchmarks can be used to project future behavior by analytically examining the trend contained in one or more of the at-risk trend or the turnaround trend.

In some embodiments, the analytics and benchmarks can be used to benchmark assessment reasons which in turn are used to suggest recommendations that provide approaches, strategies, and/or specific actions to help improve an employee's disposition. In some embodiments, the insight and learning server and system can use one or more analytics-driven logic and machine learning techniques to suggest recommendations to help the manager address issues identified during the assessments. One of the goals of the service is to identify recommendations that help a manager proactively address issues that an employee might be having. In some embodiments, the service can use machine learning to determine if one or more recommendations should be suggested for an employee.

In some embodiments, the recommendations can be created by analyzing the assessment data as well as overall company trends, industry trends, and other 3rd party information. In some embodiments, the recommendations can cover a specific topic that is meant to address a problem or issue that is associated with an assessment reason. In some embodiments, to trigger a recommendation, a set of conditions must be met. In some embodiments, recommendation actions are approaches, strategies, and/or specific actions that can be taken by a manager to improve an employee's disposition, and possible success in their role. These can be tailored by the employee role. For example, sales personnel may have different actions than software engineers. Further, each company may tailor their actions based upon their own employee guidelines and practices.

In some embodiments, predicting at-risk employees using analytical techniques involves looking at an employee's ratings over time along with the assessment reasons given. At-risk is not a binary state since an employee just starting in the at-risk category is different than one who has been in that classification for an extended period of time. As a result, there are two at-risk classifications: Watch classification and Alert classification. Watch classification is used for employees identified as at-risk start off in the “Watch” classification. This classification may be temporary and indicates a period when mitigation may be the most effective. An employee is classified as “Watch” for one of the following reasons: an employee has just transitioned into an orange or red rating, and/or an employee has just transitioned into yellow plus has one or more assessment reasons from a prescribed list of reasons. In some embodiments, for an “Alert” classification, employees can be moved into the “Alert” classification for one of the following reasons: an employee who has been in the “Watch” classification for three or more consecutive periods, and/or an employee who has had a red rating for two or more consecutive periods are considered in the “Alert” category.

Some embodiments include making recommendations. Selecting recommendations can involve using analytical techniques looking at an employee's ratings over time along with the assessment reasons given. In this instance, an employee does not need to be classified as at-risk to trigger one or more recommendations. In some embodiments, analytics based recommendations can be selected based upon “triggers”. In some embodiments, the trigger for a recommendation is backed by a formula that is based upon one or more analytical statistics. An example can include a trigger when a reason has been selected X times within a Y period or periods, and/or when one of a set of reasons has been selected X times within a Y period or periods. Other examples include a trigger when more than one from a set of reasons has been selected X times within a Y period or periods, and/or when an employee is at-risk for X times within a Y period or periods. Another example can be a trigger when an employee is at-risk and a reason has been selected for X times within a Y period or periods.

An example of one recommendation is shown in the Table 1 below:

TABLE 1
Recommendations table

| | | RECOMMENDATION | |
|---|---|---|---|
| REASONS | ROOT CAUSES | ACTION | RULE |
| Compensation | Employee tenure length | Links for each root | When mentioned 3 |
| | without much change | cause that provide | consecutive weeks in a |
| | Desire for higher | additional articles, | row or within a 6-week |
| | compensation | videos, courses, etc. | period |
| | Witnessing promotion of | | |
| | peers | | |
| | Desire for growth and | | |
| | learning management | | |
| | Long-term goals and | | |
| | intended trajectory | | |

In some further embodiments, the insight and learning server and system can support a manager with an option to add free-form notes to provide additional context for the assessment. In some embodiments, a note can be marked as private if the manager feels that it should not be seen by either his or her team members, other managers, or his or her superiors. In some embodiments, notes can be stored in the database. In some embodiments, all assessments are visible to any manager up the organization within the same reporting line, but cannot be viewed by anyone else in the organization. In some embodiments, for each of their team members, managers can see historical ratings and reasons as well as a summary of the comments for each person. In some embodiments, managers can also ‘tag’ any person by clicking on the star by their name which makes it so that they will automatically show up on the manager's dashboard under key updates. Similarly, in some embodiments, a manager can click on the people icon to jump into a person's profile on the manager's organization.

Some embodiments include adoption summaries that show a percentage of assessments performed across the manager's organization. Further, in some embodiments, it also shows the percentage of assessments performed across the manager's peer group and the company as a whole for comparison purposes.

In some embodiments, the insight and learning server and system dashboard or display can show several of the key findings and metrics in one place. In some embodiments, the following information can be shown in “widgets” on the dashboard or other type of display format. In some embodiments, directs can be shown as a list of direct reports with their last assessment rating. In this instance, a user can select one and go directly to that employee. In some further embodiments, usage performance can show the percentage of assessments performed compared to peers and company. In this instance, a user can link to the more complete view of these metrics. In some embodiments, key updates can include any tagged employees, those that have changed assessment ratings and become at risk, and the last ten rated employees. A user can select one and go directly to that employee. In some further embodiments, an at-risk feature can provide a list of employees who are considered at-risk. In some embodiments, a user can select one and go directly to that employee's profile. In some embodiments, the risk benchmark can provide a benchmark of user's assessment ratings over time compared to peers and company. In some embodiments, a user can link to the more complete view of these metrics. In some embodiments, the top reasons can show the top three assessment reasons of at-risk employees. In some embodiments, a user can also link to the more complete view.

For example, some non-limiting examples of analytics of the insight and learning server and system are shown in FIGS. 6A-6I. In some embodiments of the invention, the insight and learning server and system can calculate and display one or more trends of sentiment. For example, FIG. 6A illustrates a sentiment trend chart in accordance with some embodiments of the invention. In some embodiments, the sentiment trend can be shown for one or more functions or part of a company or team. For example, the non-limiting embodiments of FIG. 6A shows sentiment plots for information technology, operations, sales and marketing, and finance portions of a company, teams or groups. In some embodiments, a company benchmark of sentiment can be shown.

In some embodiments of the invention, the insight and learning server and system can calculate and display one or more sentiment distribution statistics. For example, FIG. 6B illustrates a sentiment distribution chart in accordance with some embodiments of the invention. In some embodiments, the sentiment distribution can be shown as a function of one or more of the aforementioned sentiment rating, including, but not limited to, “not good”, “struggling”, “so-so”, “mostly ok”, and “doing great”. In some embodiments, each distribution can be shown as a sentiment color as described earlier.

In some embodiments of the invention, the insight and learning server and system can calculate and display statistics of reasons. For example, FIG. 6C illustrates a cumulative reasons chart in accordance with some embodiments of the invention. In some embodiments, a cumulation bar chart can represent positive and/or negative sentiment cumulatively represented by the relative lengths of the bars for each reason (y-axis).

In some embodiments of the invention, the insight and learning server and system can calculate and display statistics of cited reasons. For example, FIG. 6D illustrates a reasons trend chart in accordance with some embodiments of the invention. As shown in this non-limiting embodiment, in some embodiments, cumulative cited reasons (y-axis) can be shown as a function of negative reason or positive reason, and a trend line can be shown for each.

In some embodiments of the invention, the insight and learning server and system can calculate and display statistics of at-risk trends. For example, FIGS. 6E-6F illustrate at-risk trend charts in accordance with some embodiments of the invention. As shown in FIG. 6E, in some embodiments, the at-risk trend can be shown for one or more functions or part of a company or team. For example, at-risk plots of information technology, operations, sales and marketing, and finance portions of a company, teams or groups can be calculated and displayed. In some embodiments, a company benchmark of sentiment can be shown. In reference to FIG. 6F, in some embodiments, at-risk trend data can be shown and/or misalignment can be calculated and displayed. In some embodiments, these trends can be displayed as a function of time as shown. Further, n some embodiments of the invention, the insight and learning server and system can calculate and display statistics of misalignments in sentiment and trends. For example, FIGS. 6G-6H illustrate misaligned trend charts in accordance with some embodiments of the invention. In some embodiments, sentiment misalignment can be shown as a function of one or more functions or part of a company or team. For example, plots of information technology, operations, sales and marketing, and finance portions of a company, teams or groups can be calculated and displayed. In some embodiments, a company benchmark of sentiment can be shown. Further, as shown in FIG. 6H, in some embodiments, aligned or misaligned data can be shown as a function of time.

In some embodiments of the invention, the insight and learning server and system can calculate and display statistics of check-in behavior. For example, FIG. 6I illustrates an assessment trends chart in accordance with some embodiments of the invention. In some embodiments, the check-in statistics can be shown for one or more functions or part of a company or team. For example, plots of information technology, operations, sales and marketing, and finance portions of a company, teams or groups can be calculated and displayed. In some embodiments, a company benchmark of sentiment can be shown.

In some embodiments, the insight and learning server and system dashboard or display can serve as the “home” page for the manager, and can provide a focused view of their organizational health. In some embodiments, each of the visualizations on the dashboard or display can serve a different purpose. For example, in some embodiments, frequent and regular assessments are an important tool to improve communication and trust with employees and to deal with issues early before they become major problems. In some embodiments, a usage performance information window or widget can show how well the organization is completing its assessments and/or can encourage continued use. Since it is difficult to track changes in an organization, especially significant ones like an employee's declining assessment rating, a key updates widget can identify employees where their rating has changed, and can also show employees that a manager has tagged for tracking. Further, in some embodiments, an organization's at-risk employees can be shown in the at-risk widget as a way of highlighting employees requiring special attention. In some embodiments, a risk benchmark widget can show the manager's organizational average rating compared to their peer and company averages, giving the manager a quick pulse of their organization. In some embodiments, one or more reasons for an employee being at-risk are important to understand what might be happening, and in determining how to address the situation. In some embodiments, a top reasons widget can represent the top reasons associated with at-risk employees in the manager's organization.

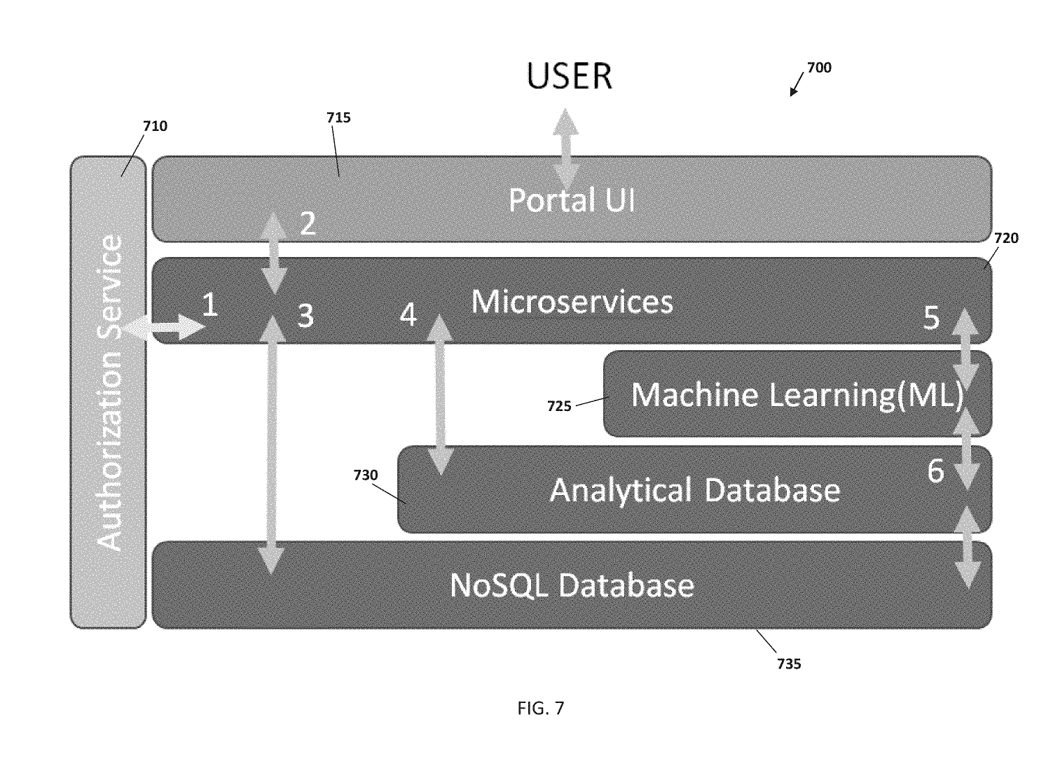

In some embodiments, the insight and learning server and system can include creation of a company account, and all employees in a company can share the email domain of the company. In some embodiments, a company must first be defined in the insight and learning server and system by entering a valid email domain which is stored in the database. In some embodiments, when a user first accesses the portal, they can be asked to register by providing their employee email, name, and title (e.g., see portal 715 of FIG. 7). In some embodiments, before a company can use the insight and learning server and system, the new email domain must be registered by an administrator of manager insight and learning system. In some embodiments, if the email domain is defined in the system, then an entry will be created in the authentication insight and learning server and system for the user that will be marked “pending”.

In some embodiments, in order to verify an employee's email address, the service can send an email to the employee email which contains an expiring code that they must enter into the portal. In some embodiments, when this is done successfully, the user's status in the database changes from “Pending” to “Active”, and the user can log into the service. In some embodiments, employee teams are a critical relationship within the service and are often used for analytics and benchmarks. In some embodiments, teams can be determined organically within the insight and learning server and system using one or more of the mechanisms outlined as follows. In some embodiments, the insight and learning server and system can set up the team where a manager initially sets up the directs on their team, and the portal provides the ability to specify the employees on his or her team by entering the employees' email addresses. In some embodiments, if an employee with the specified employee email is not shown in the database, the manager must enter the employee's name and title which is entered into the database, and the employee's manager is set to the manager.

FIG. 7 illustrates a service component architecture 700 of the insight and learning server and system in accordance with some embodiments of the invention. In some embodiments, the service component architecture 700 illustrates the primary components in the service architecture, and how they relate to each other. In some embodiments, the service can be delivered as a SaaS (Software as a Service) application and can be deployed at Amazon® Web Services (“AWS”), or other conventional cloud-based service. In some embodiments, the blocks 710, 715, 720, 725, 730, 735 represent the primary components in the architecture. In some embodiments, the arrows represent the main data flow between them that is implemented as a “RESTful” API. Each arrow represents a different API and identifies which components communicate using the API. In some embodiments, the numbered APIs are described in more detail in the sections which follow.

Unless specified or limited otherwise, the term “service” refers to the total software, database, algorithms, and user interface that creates the functionality provided by the system. Unless specified or limited otherwise, the database can be a “NoSQL” (or “non-SQL” or “non-relational”) 735 or a “SQL” (“relational”) database that provides a mechanism for storage and retrieval of data. In some embodiments, the database can warehouse the objects and relationships that represent the components of the system. In some embodiments, the database structure includes tables that are comprised of items and indices.

Unless specified or limited otherwise, “microservices” refers to software that embodies the logic of the service organized as a suite of component services, each running in its own process and communicating with HTTPS using a “REST” application program interface (“API”), and deployed by a fully automated deployment mechanism. Some embodiments include a machine learning method of data analysis that automates analytical model building used to predict future behavior and/or outcomes. Unless specified or limited otherwise, a “portal” can be a user interface utilized by users of the service. Unless specified or limited otherwise, users can be service users. Unless specified or limited otherwise, analytics define algorithmic results derived from analyzing data in the database and/or third-party sources. Unless specified or limited otherwise, benchmarks can be analytic results viewed over a time period that are used for comparative purposes. Unless specified or limited otherwise, recommendations can consist of recommended approaches, strategies, and/or specific actions to help manage and lead that are based upon the ratings and reasons entered for an employee's personal situation.

In some embodiments, the authorization service 710 can be used to authenticate all users of the service. In some embodiments, the authorization service 710 can provide secure sign-up and sign-in functionality and can scale to support hundreds of millions of users, and can provide optional security features such as email and phone number verification, and multi-factor authentication. In some embodiments, the primary technology used for the authorization service is Security Assertion Markup Language (SAML). This technology enables single sign-on whereby users may log in using their corporate credentials and will be validated by their employer's SAML authentication and authorization service 710. Once authorized, the authentication and authorization service will pass the identity of the user to the platform which will then be able to provide the service to the user.

In some embodiments, a server running the portal user interface (“portal UI” 715) can provide browser-based service access to users, including, but not limited to inclusion on a mobile application for mobile users. In some embodiments, user service access can be via embedded Add-ons and Add-ins. For example, a Microsoft® Outlook Add-in can be made available to users to provide access to the service. In some embodiments, this is the primary user interface for users. In some embodiments, the portal UI 715 supports normal wide screen access from laptops, etc., and also provides an optimized version for mobile devices. In some embodiments, the primary technologies used for the implementation of the portal UI 715 can be React and JavaScript. In some embodiments, the primary API used by the portal UI 715 can be the microservices API 720, and are the server side of the service. In some embodiments, when the UI needs information from the database or to perform an action like create an employee or send an email, it can use the microservice API 720.

In some embodiments, the server-side software can be implemented using a no-server design. This means that the server-side logic can be implemented using microservices that are deployed and executed on an as-needed basis. This allows for flexible scaling of resources based upon an increase or decrease of demand. In some embodiments, the microservice RESTful API can use a technology called GraphQL for the API protocol. GraphQL is an API query language, developed by Facebook Inc., that defines a syntax to specify the query type and exactly the data requested. GraphQL provides a very flexible mechanism to extend the capabilities of the API over time without needing to extend the API itself. It also makes it possible for the UI to ask for only the information needed to streamline the amount of data exchanged. In some embodiments, the microservices can support database update and access, including changes to the database itself, and analytics access, including receiving analytics results, and email access, with a trigger sending emails for various purposes.

In some embodiments, the primary technologies used for implementing microservices can be AWS lambda and Node.js®, and the main service database can be a NoSQL (non-relational) database 735. In some embodiments, the database can be accessed by microservices 720 using an API. In some embodiments, the data items in the database can be stored as objects organized into tables, and each company can have its own set of tables. In some embodiments, the main tables can be a domain table providing a list of valid domains supported in the service, an employee table providing a list of employees in a company and hierarchical relationship between them, and an assessment table including all employee assessments for a company.

Several indices can allow quick access to subsets of the data. For example, there can be an index on the employees table that contains a manager ID which allows quick access to a manager's employees. In some embodiments, the primary technology used for the NoSQL database 735 can be AWS DynamoDB.

In some embodiments of the invention, the analytical database 730 can be a read-only database that can store historical data and trend statistics that are key for generating service insights (detailed in section—analytic data). The trend statistics can summarize results over a period of time for a team or set of teams. For example, the last six months, for each team, the system can calculate the number of direct reports who are rated yellow or below in an organization. In some embodiments, this information can be calculated in real-time and/or in batch mode, and the results can be stored in the analytical database 730 to improve performance and/or simplify more complex algorithms. In some embodiments, the machine learning 725 can rely on the analytics in this database. In some embodiments, the analytical database 730 can be queried using SQL queries by microservices over an API. In some embodiments, the analytical database 730 can be created from the data in the NoSQL database 735 using an API. In some embodiments, the primary technology used for the analytics database is AWS® Redshift.

Some embodiments include a machine learning (“ML”) (e.g., component 725) that can be accessed by microservices using an API (720). In some embodiments, the ML component 725 of the service component architecture 700 can be used primarily to identify at-risk employees, select one or more relevant recommendations for an employee, and identify predictive trends of future behavior. In some embodiments, the use of the ML component 725 can be key to learning from the assessment results to determine how best to improve an employee's disposition and select the “best” plan of action. As a result, in some embodiments, the ML component 725 can be used both for features in the service component architecture 700, but also for off-line data mining activities to improve the feedback provided by the service.

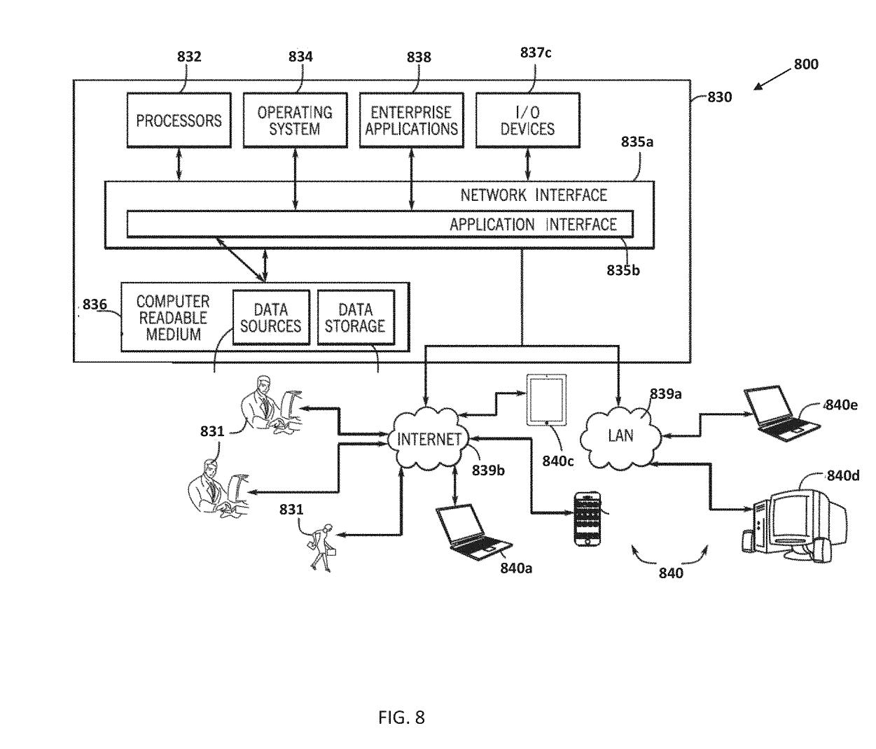

FIG. 8 illustrates a computer system 800 configured for operating and processing one or more components of the insight and learning server and system in accordance with some embodiments of the invention. In some embodiments, the computer system 800 can process one or more software modules of the insight and learning server and system applications, enabling the computer system 800 to display information related to the insight and learning server and system within one or more graphical user interfaces (e.g., in one or more of an employee and/or manager displays or dashboards described earlier). In some embodiments, the computer system 800 can process one or more insight and learning server and system application services. Further, the computer system can also manage the organization of data and data flow between the insight and learning server and system application services, front end systems and servers, back end systems and servers, and external or remote (third party) computer systems.

In some embodiments, the computer system 800 can comprise at least one computing device including at least one processor 832. In some embodiments, the at least one processor 832 can include a processor residing in or coupled to one or more server platforms. In some embodiments, the computer system 800 can include a network interface 835a and an application interface 835b coupled to the least one processor 832 capable of processing at least one operating system 834. Further, in some embodiments, the interfaces 835a, 835b coupled to at least one processor 832 can be configured to process one or more of the software modules (e.g., such as enterprise applications 838). In some embodiments, the software modules 838 can include server-based software that can include insight and learning server and system software modules. In some embodiments, the software modules 838 can operate to host at least one user account and/or at least one client account, and operating to transfer data between one or more of these accounts using the at least one processor 832.

With the above embodiments in mind, it should be understood that the invention can employ various computer-implemented operations involving insight and learning server and system data stored in computer systems. Moreover, the above-described databases and models throughout the insight and learning server and system can store analytical models and other data on computer-readable storage media within the computer system and on computer-readable storage media coupled to the computer system. In addition, the above-described applications of the insight and learning server and system can be stored on computer-readable storage media within the computer system and on computer-readable storage media coupled to the computer system. These operations are those requiring physical manipulation of physical quantities. Usually, though not necessarily, these quantities take the form of electrical, electromagnetic, or magnetic signals, optical or magneto-optical form capable of being stored, transferred, combined, compared and otherwise manipulated.

In some embodiments of the invention, the computer system 800 can comprise at least one computer readable medium 836 coupled to at least one data source 837a, and/or at least one data storage device 837b, and/or at least one input/output device 837c. In some embodiments, the invention can be embodied as computer readable code on a computer readable medium 836. In some embodiments, the computer readable medium 836 can be any data storage device that can store data, which can thereafter be read by a computer system (such as the computer system). In some embodiments, the computer readable medium 836 can be any physical or material medium that can be used to tangibly store the desired information or data or instructions and which can be accessed by a computer or processor 832. In some embodiments, the computer readable medium 836 can include hard drives, network attached storage (NAS), read-only memory, random-access memory, FLASH based memory, CD-ROMs, CD-Rs, CD-RWs, DVDs, magnetic tapes, other optical and non-optical data storage devices. In some embodiments, various other forms of computer-readable media 836 can transmit or carry instructions to a computer 40 and/or at least one user 831, including a router, private or public network, or other transmission device or channel, both wired and wireless. The software modules 838 can be configured to send and receive data from a database (e.g., from a computer readable medium 836 including data sources 837a and data storage 837b that can comprise a database), and data can be received by the software modules 838 from at least one other source. In some embodiments, at least one of the software modules 838 can be configured within the computer system to output data to at least one user 831 via at least one graphical user interface rendered on at least one digital display.

In some embodiments of the invention, the computer readable medium 836 can be distributed over a conventional computer network via the network interface 835a where the insight and learning server and system embodied by the computer readable code can be stored and executed in a distributed fashion. For example, in some embodiments, one or more components of the computer system can be coupled to send and/or receive data through a local area network (“LAN”) 839a and/or an internet coupled network 839b (e.g., such as a wireless internet). In some further embodiments, the networks 839a, 839b can include wide area networks (“WAN”), direct connections (e.g., through a universal serial bus port), or other forms of computer-readable media 836, or any combination thereof.

In some embodiments, components of the networks 839a, 839b can include any number of user devices such as personal computers including for example desktop computers, and/or laptop computers, or any fixed, generally non-mobile internet appliances coupled through the LAN 839a. For example, some embodiments include personal computers 40 coupled through the LAN 839a that can be configured for any type of user including an administrator. Other embodiments can include personal computers 840 coupled through network 839b. In some further embodiments, one or more components of the computer system can be coupled to send or receive data through an internet network (e.g., such as network 839b). For example, some embodiments include at least one user 831 coupled wirelessly and accessing one or more software modules of the insight and learning server and system including at least one enterprise application 838 via an input and output (“I/O”) device 837c. In some other embodiments, the computer system can enable at least one user 831 to be coupled to access enterprise applications 838 via an I/O device 837c through LAN 839a. In some embodiments, the user 831 can comprise a user 831a coupled to the computer system using a desktop computer, and/or laptop computers, or any fixed, generally non-mobile internet appliances coupled through the internet 839b. In some further embodiments, the user 831 can comprise a mobile user 831b coupled to the computer system. In some embodiments, the user 831b can use any mobile computing device 831c to wireless coupled to the computer system, including, but not limited to, personal digital assistants, and/or cellular phones, mobile phones, or smart phones, and/or pagers, and/or digital tablets, and/or fixed or mobile internet appliances. In some embodiments, a user can use the display of a mobile device (e.g., such as a smart phone) to select a person and/or to enter an overall rating. Further, the mobile display can be used to select the employee's drivers, and can be used to update the file with notes. In some embodiments, any of the mobile displays can be used to display at least a portion of any of the display, windows, or widgets shown and described herein.

In some embodiments, the computer system 800 can enable one or more users 831 coupled to receive, analyze, input, modify, create and send data to and from the computer system, including to and from one or more enterprise applications 838 running on the computer system. In some embodiments, at least one software application 838 running on one or more processors 832 can be configured to be coupled for communication over networks 839a, 839b through the internet 839b. In some embodiments, one or more wired or wirelessly coupled components of the network 839a, 839b can include one or more resources for data storage. For example, this can include any other form of computer readable media in addition to the computer readable media 836 for storing information, and can include any form of computer readable media for communicating information from one electronic device to another electronic device.

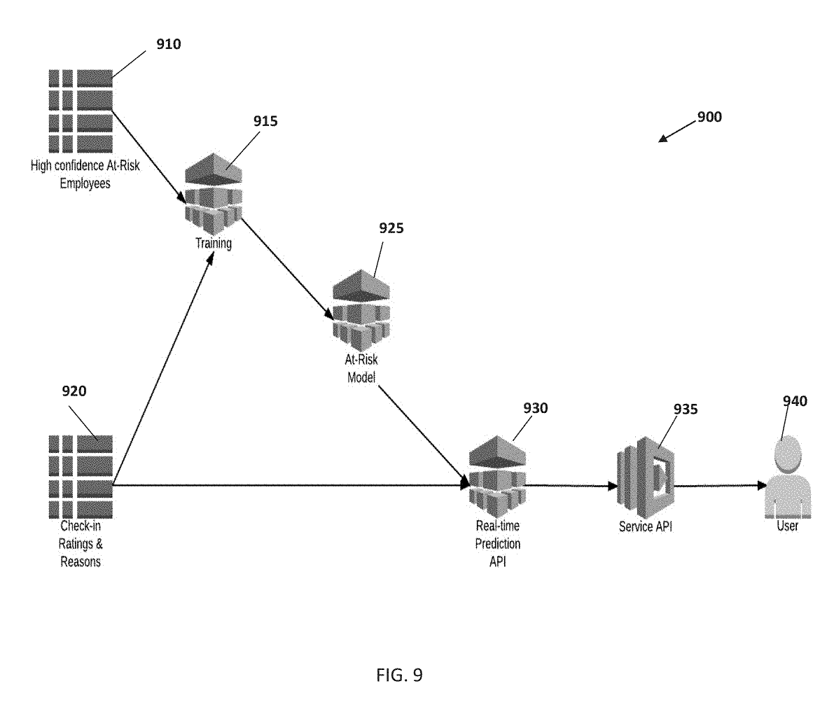

In some embodiments, the primary technology used for the ML engine is AWS® machine learning. The ML model used is the multi-class classification model. For training multiclass models, Amazon® ML uses the industry-standard learning algorithm known as multinomial logistic regression. FIG. 9 shows a machine learning for an at-risk employee architecture of the insight and learning server and system in accordance with some embodiments of the invention. For machine learning, it is first necessary to train the ML model using data with a known outcome. In some embodiments, the model training for predicting at-risk employees involves using data from past assessment ratings (e.g., see input from databases 910, 920), including employees that have left the company, and/or employees that have steadily declining ratings, and/or employees that have reasons that are known to be particularly problematic, and/or employees that move to another team for non-business reasons. Using this information, to set the “at-risk” target attribute in the training data (training module 915) allows the model (925) to train on that attribute. In some embodiments, the model is improved over time as more data is accumulated, especially data related to employees that leave the company. In some embodiments, this illustrates ML training and deployment applied to the problem of determining which recommendations should be suggested for an employee. In some embodiments, the model training for predicting recommendations involves using the following data from past assessments including recommendations that were manually selected by a manager, and employees that have reasons that are known to be particularly problematic. Using this information to set the “recommendation” target attribute in the training data allows the model to train on that attribute. In some embodiments, the model is improved over time as more data is accumulated, especially by feedback steps including a first feedback when a manager is presented with recommendation suggestions and is asked to select one or more that are relevant for that employee's situation, where the selections that he or she makes will reinforce the correct selection for that situation. In some embodiments, a second feedback includes the service following up with a manager and to ask him/her to rate the effectiveness of the recommendation that had been selected for that employee. In some embodiments, both of these feedback loops can provide a useful result on which the model may be trained further. Some embodiments implement a modern server-less API architecture (real-time prediction API 930 couple to service API 935) which can be scaled as necessary to match the demands of a growing service for one or more users 940.

In some embodiments, the insight and learning server and system can be scaled. For example, in some embodiments, the infrastructure scaling can be achieved by the architecture chosen (e.g., see service component architecture 700 of FIG. 7). The main scaling components can be microservices and the NoSQL or relational database as shown. Microservices spawn a function for every request from the portal UI, and there is no practical limit to the number of microservice functions that can be created. In some embodiments, the NoSQL database can use a cluster implementation that can be scaled based on the number of simultaneous read and write requests, and there is no practical limit since the cluster is designed to scale as needed.

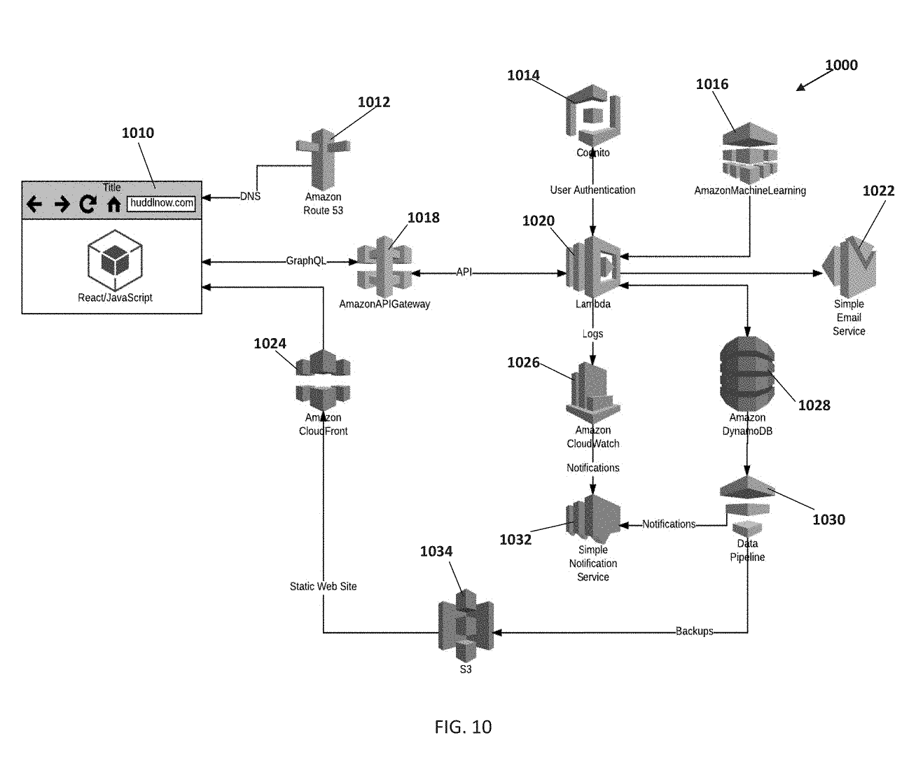

Some embodiments can utilize AWS components that implement the service components shown in FIG. 10 (architecture 1000), showing a machine learning for an at-risk employee architecture of the insight and learning server and system in accordance with some embodiments of the invention. This design implements a modern server-less API architecture which can be scaled as necessary to match the demands of a growing service, and include one or more coupled servers, databases, and API's, including, but not limited to a scalable cloud Domain Name System (DNS) web service Amazon® Route 53 (1012). Amazon® API Gateway (1018) is a fully managed service that makes it easy for developers to create, publish, maintain, monitor, and secure APIs at any scale. In some embodiments, the architecture 1000 can comprise an API Gateway that is integrated with AWS Lambda (1020). Some embodiments include a monitoring and management service such as Amazon® CloudWatch (1026), a notification service such as Amazon® Simple Notification Service (1032), a content delivery network (CDN) service that securely delivers data, videos, applications, and APIs to customers such as Amazon® CloudFront (1024). Some embodiments utilize Amazon® Cognito (1014), and/or a simple email service (1022). Some embodiments include Amazon® Machine Learning (1016) that provides visualization tools and wizards that guide you through the process of creating ML models. Some embodiments include a fully managed proprietary NoSQL database service that supports key-value and document data structures and is offered by Amazon.com as part of the Amazon Web Services portfolio such as Amazon® DynamoDB (1028). Some embodiments include Amazon® S3 (1034) (Amazon® Simple Storage Service) which is a “simple storage service” offered by Amazon® Web Services that provides object storage through a web service interface, and provides a web interface to easily store and retrieve data safely. Some embodiments include the use of at least one data pipeline (1030). Amazon® is a registered trademark of Amazon® Technologies, Inc.

The following describes a list of the main software tools used for the development of the service. Some embodiments include JavaScript ReactJS (1010). ReactJS supports building encapsulated components in JavaScript that manage their own state that are used to compose complex UIs. This allows a true object-oriented approach to building the service's UI. Some further embodiments utilize GraphQL, a query language for APIs and a runtime for fulfilling those queries with existing data. The GraphQL provides a complete and understandable description of the data in your API, gives clients the power to ask for exactly what they need and nothing more, makes it easier to evolve APIs over time, and enables powerful developer tools. Some further embodiments utilize Node.js®, a JavaScript runtime built on Google's V8 JavaScript engine. Node.js® uses an event-driven, non-blocking I/O model that makes it lightweight and efficient. Some other embodiments utilize Git™, a version control system for tracking changes in computer files and coordinating work on those files among multiple people. Nodejs® is a registered trademark of the Node.js Foundation. Git™ “Git and the Git logo are either registered trademarks or trademarks of Software Freedom Conservancy, Inc., corporate home of the Git Project, in the United States and/or other countries.” when you need to mention “Git” in e.g. list of trademarks held by other people

In some embodiments, if the employee and manager ratings have been determined to be significantly different (using one or more of the analytical techniques mentioned previously), the system can notify the manager on the platform that there is a misalignment, and they need to “dig in” or further analyze with the employee (without providing the specifics and violating the employee confidentiality.) In some embodiments, once that manager meets with that employee and determines one or more reasons for the misalignment, they can update/correct their initial rating in the platform, and any new actions and recommendations can be generated for that specific employee.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g. a cloud of computing resources.

The embodiments of the present invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally or in particular formats that enable the construction or depiction of a physical and tangible object. In some embodiments, the manipulation can be performed by a processor. In such an example, the processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations can be described in a specific order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the description, figures, and claims herein.

1. A system, comprising:
at least one processor;
a non-transitory computer-readable storage medium for tangibly storing thereon program logic for execution by the processor, the program logic comprising:
logic executed by the processor for creating a rating display including an interactive questionnaire, display, menu or list with at least some sentiment-related information;
logic executed by the processor for receiving employee sentiment data generated based on the rating display, the employee sentiment data comprising at least in part one or more employee check-ins and/or one or more manager check-ins or inputs to the sentiment-related information displayed by the rating display;
logic executed by the processor for storing in at least one database at least a portion of the employee sentiment data;
logic executed by the processor for creating sentiment profiles of one or more employees, the sentiment profiles comprising at least one of at least one sentiment rating and at least one associated sentiment reason, and at least one associated learning; and
logic executed by the processor for linking a display of at least one of the at least one sentiment rating, the at least one associated sentiment reason, and the at least one associated learning to educational materials.

2. The system of claim 1, wherein the overall sentiment is displayed as a colored graphic wherein one or more colors of the colored graphic indicates or represents a certain sentiment.

3. The system of claim 2, wherein the overall sentiment is displayed including at least one of the color of the graphic comprises a red color and the certain sentiment is “not good”, the color of the graphic comprises an orange color and the certain sentiment is “struggling”, the color of the graphic comprises a yellow color and the certain sentiment is “generally okay or so-so”, the color of the graphic comprises a light green color and the certain sentiment is “mostly okay”, the color of the graphic comprises a green color and the certain sentiment is “doing great”.

4. The system of claim 2, wherein the overall sentiment comprises at least one of “not good”, “struggling”, “generally okay or so-so”, “mostly okay”, and “doing great” displayed as a colored graphic with a color different from a different overall sentiment.

5. The system of claim 1, wherein the sentiment reason is a positive or negative reason comprising at least one of their peers, team and colleagues, company direction, mission and/or goals, recognition for their work, events unrelated to work, their personal growth at the company, their role, duties, and challenges.

6. The system of claim 5, wherein selectable responses to the positive or negative reason of peers, team and colleagues includes their direct reports, members of other teams or departments, and peers on their team.

7. The system of claim 5, wherein selectable responses to the positive or negative reason of company direction, mission, and/or goals includes corporate mission, company outlook, leadership, and recent major changes.

8. The system of claim 5, wherein selectable responses to the positive or negative reason of recognition for their work includes feedback from others, compensation, and job title.

9. The system of claim 5, wherein selectable responses to the positive or negative reason of events unrelated to work includes events unrelated to work.

10. The system of claim 5, wherein selectable responses to the positive or negative reason of their personal growth at the company includes a career growth plan.

11. The system of claim 5, wherein selectable responses to the positive or negative reason of their role, duties, and challenges includes feeling challenged, appropriate resources and resourcing, personal empowerment, and job or interest alignment.

12. The system of claim 1, wherein the educational materials comprise at least one of educational articles, webinars, videos, research papers, studies, worksheets, and education media content.

13. A system comprising:
a memory storing software instructions;
a computer server configured by the software instructions to:
calculate sentiment and/or risk profiles from one or more employee check-ins or one or more manager check-ins or inputs to sentiment related information displayed by an interactive questionnaire or display; and
use machine learning to identify and select one or more communications or communication sources including content comprising at least one of links to or articles or news, social media, videos, media content, articles, aimed at addressing one or more concerns and increasing a level of sentiment of an employee;
use machine learning to improve content by using feedback from the machine learning of the system by at least:
tracking access of at least a portion of the content by one or more employees; and
updating at least a portion of the content based on the machine learning of access to at least a portion of the content.

14. A system comprising:
at least one processor;
a non-transitory computer readable storage medium encoded with a computer program comprising instructions that when executed by the one or more processors, perform operations comprising:
receiving employee sentiment data from an interactive display generated by the instructions, the sentiment data comprising one or more employee check-ins or one or more manager check-ins or inputs to sentiment related information displayed by the interactive questionnaire or display;
calculating a sentiment and risk profile from the sentiment data; and
generating a manager notification comprising of one or more of alert to at least one direct or indirect manager of the employee based on a predetermined level of sentiment and/or risk.

15. A system comprising:
at least one processor;
a non-transitory computer readable storage medium encoded with program logic for execution by the at least one processor, the program logic comprising:
logic executed by the at least one processor for
receiving employee sentiment data from an interactive employee-dedicated questionnaire or display generated by the instructions, a first sentiment data comprising one or more employee check-ins or inputs to sentiment related information displayed by the interactive questionnaire or display, and second sentiment data comprising one or more manager check-ins or inputs to sentiment related information displayed by a manager dedicated interactive questionnaire or display;
logic executed by the at least one processor for
performing a comparative analysis of the first and second sentiment data; and
logic executed by the at least one processor for
generating an alert message or display based on a predetermined level of difference between the first and second sentiment data.

16. The system of claim 15, wherein the comparative analysis is a substantially double-blind comparative analysis.

17. A server system comprising:
at least one processor;
a non-transitory computer-readable storage medium for tangibly storing thereon program logic for execution by the processor, the program logic comprising:
logic executed by the processor for creating a check-in display including at least one interactive display with at least some sentiment-related questions or information associated with at least one employee;
logic executed by the processor for receiving data communications from inputs to the check-in display, the data communications comprising sentiment data check-in responses associated with the at least one employee; and
logic executed by the processor for creating at least one sentiment profile of the at least one employee.

18. A server system comprising:
at least one processor;
a non-transitory computer-readable storage medium for tangibly storing thereon program logic for execution by the processor, the program logic comprising:
logic executed by the processor for creating an interactive employee check-in display;
logic executed by the processor for receiving data communications from inputs to the employee check-in display, the data communications comprising employee sentiment data; and
logic executed by the processor for creating at least one sentiment profile of the employee;
logic executed by the processor for creating an interactive manager check-in display including at least some sentiment-related questions, queries, or information associated with the employee;
logic executed by the processor for receiving data communications from inputs to the manager check-in display, the data communications comprising responses to questions or information concerning a manager's sentiment rating of at least one employee and at least one associated reason; and
logic executed by the processor for performing a comparative analysis of the at least one employee sentiment and associated reason and the at least one manager sentiment rating; and generating a manager notification comprising of one or more of alert message, email communication, or display based on a predetermined level of difference between the at least one employee sentiment and associated reason and the at least one manager sentiment rating.

19. A server system comprising:
at least one processor;
a machine-learning data server including employment history data of at least one employee;
a non-transitory computer-readable storage medium for tangibly storing thereon program logic for execution by the processor, the program logic comprising:
logic executed by the processor for receiving data communications from inputs to an employee check-in display, the data communications comprising employee sentiment data responses to the questions or information on the check-in display; and
logic executed by the processor creating at least one sentiment profile of an employee using at least a portion of the employment history data received from the machine-learning data server and at least some of the employee sentiment data responses.

20. The server system of claim 19, further comprising logic executed by the processor for creating based at least in part on the sentiment profiles, one or more risk profiles of the employee; the risk profiles comprising at least one of:
quantified risk data displayed on a manager display against a risk benchmark, quantified risk data displayed on a manager display based on cumulative time at a risk level, and quantified risk data displayed on a manager display based on a risk comparison history over time.

21. The server system of claim 19, further comprising logic executed by the processor for using machine-learning based at least in part on the at least one sentiment profile to offer selectable access to educational content comprising at least one of educational articles, webinars, videos, research papers, studies, worksheets, and education media content.

22. The server system of claim 19, further comprising logic executed by the processor for using machine learning to improve the educational content.

23. A server system comprising:
at least one processor;
a non-transitory computer-readable storage medium for tangibly storing thereon program logic for execution by the processor, the program logic comprising:
logic executed by the processor for receiving data communications from inputs to an employee check-in display, the data communications comprising employee sentiment data responses and at least one associated reason to questions or information;
logic executed by the processor for receiving data communications from inputs to a manager check-in display, the data communications comprising responses to the questions or information concerning a manager's sentiment rating of employee and associated reason;
logic executed by the processor for performing a comparative analysis of the employee sentiment and associated reason and the manager sentiment rating; and
logic executed by the processor for using machine learning to select targeted learning content based at least in part on a quantified level of value of the learning content when selected based on the employee sentiment and associated reason, and the manager sentiment rating.

24. The server system of claim 23, further comprising:
logic executed by the processor for using machine learning to update the targeted learning content based at least in part on the quantified value.

25. The server system of claim 18, further comprising:
logic executed by the processor for performing the comparative analysis using one or more of the sentiment profile, at least one manager's check-in, at least one employee check-in, and machine learning to determine if the manager notification should be made.

26. The system of claim 14, further comprising:
logic executed by the processor for performing at-risk analysis using one or more of the sentiment and risk profile, at least one manager's check-in, at least one employee check-in, and machine learning to determine if the manager notification should be made.

27. The server system of claim 25, further comprising logic executed by the processor for using machine learning to improve the comparative analysis.

28. The system of claim 26, further comprising logic executed by the processor for using machine learning to improve at-risk determination.
